(19) United States
(12) Patent Application Publication
(10) Pub. No.: US 2013/0179910 A1
(43) Pub. Date: Jul. 11, 2013

(54) TERMINAL DEVICE, CONTENT DISPLAY METHOD FOR TERMINAL DEVICE, SERVER DEVICE, DISPLAY DATA TRANSMISSION METHOD FOR SERVER DEVICE, AND RANKING INFORMATION TRANSMISSION METHOD FOR SERVER DEVICE

(71) Applicant: Akimitsu Hio, Tokyo (JP)

(72) Inventor: Akimitsu Hio, Tokyo (JP)

(73) Assignee: Sony Corporation, Tokyo (JP)

(21) Appl. No.: 13/823,850

(22) PCT Filed: Oct. 14, 2011
(86) PCT No.: PCT/JP2011/073743

§ 371 Date: Mar. 15, 2013

(30) Foreign Application Priority Data
Nov. 4, 2010 (JP) 2010-247127

(51) Int. Cl. H04N 21/442

(52) U.S. Cl. CPC H04N 21/44213
USPC 725/10

(57) ABSTRACT

A viewer who views predetermined content displayed on a display panel has sympathy even when a few people views the predetermined content around the viewer.

A center server 100 generates ranking information based on viewer number information of a location terminal 200 (200-1 to 200-N) installed in each store, and generates display data of the predetermined content. The display data includes content data for displaying the predetermined content on a first display region and image data for displaying viewer-captured images of a predetermined number of location terminals selected based on the ranking information on a predetermined number of second display regions. The center server 100 transmits the display data to the location terminal 200. The location terminal 200 causes the predetermined content and the viewer-captured images of the predetermined number of location terminals to be displayed on a display panel based on the display data at a display timing of the predetermined content.

### TECHNICAL FIELD

The invention relates to a terminal device, a content display method of a terminal device, a server device, a display data transmission method of a server device, and a ranking information transmission method of a server device, and more particularly, to a terminal device that displays content transmitted from a server device via a network.

### BACKGROUND ART

Systems in which information supplied from a server connected to a network is displayed on a display panel installed in stores or public places to provide information to many people are called, for example, signage systems or digital signages, and have been recently used in various places. The signage systems are disclosed, for example, Patent Documents 1, 2, and 3.

For example, the following system can be used in stores such as supermarkets as the signage system. There is a system in which a store terminal (for example, a display panel) is installed in each of stores that configure a chain of supermarkets, and displays a variety of information such as bargain sale information, store guide, or product advertising. Using this system, a variety of information can be provided to shoppers. The output information of the store terminal can be delivered from a server connected with the store terminal via a network, and for example, content can be timely delivered and displayed in many chain stores.

In the signage system, for example, the viewer who views advertising content displayed on the display panel of the store terminal has sympathy and gets interested in when many people view the advertising content around the viewer. As the viewer gets interested in, the viewer is likely to be drawn to the advertising content, and the advertising effect is improved. For example, Patent Document 4 discloses a technique of measuring the number of viewers of advertising content which is being displayed and measuring an advertising effect. Further, for example, Patent Document 5 discloses a technique of acquiring a degree of interest of viewers who is viewing program content based on the viewer's video information captured by a camera or the viewer's audio information captured by a microphone, and extracting the highlights of the program content.

### CITATION LIST

### Patent Documents

Patent Document 1: Japanese Patent Application Laid-Open No. 2009-134694
Patent Document 2: Japanese Patent Application Laid-Open No. 2009-276934
Patent Document 3: Japanese Patent Application Laid-Open No. 2009-20361
Patent Document 4: Japanese Patent Application Laid-Open No. 2008-112401
Patent Document 5: Japanese Patent Application Laid-Open No. 2010-016482

### SUMMARY OF THE INVENTION

### Problems to be Solved by the Invention

As described above, in the signage system, for example, the viewer who views advertising content displayed on the display panel of the store terminal has sympathy and gets interested in when many people view the advertising content around the viewer. However, when a few people view the advertising content around the viewer, the viewer neither has sympathy nor gets interested in. In this case, the viewer is difficult to be drawn to the advertising content, and the advertising effect is lowered.

The invention is directed to causing the viewer who views predetermined content such as advertising content displayed on a display panel to have sympathy and get interested in even when a few people views the predetermined content around the viewer.

### Solutions to Problems

a concept of the present invention lies in

a terminal device, including:

a display data receiving unit that receives display data from a server device, the display data including content data for displaying predetermined content on a first display region and captured-image data for displaying viewer-captured images of the predetermined content of a predetermined number of terminal devices on a predetermined number of second display regions; and

a display control unit that causes the predetermined content and the viewer-captured images of the predetermined number of terminal devices to be displayed on a display panel based on the display data received by the display data receiving unit.

In the invention, the display data receiving unit receives the display data from the server device. The display data includes content data for displaying predetermined content on a first display region and captured-image data for displaying viewer-captured images of the predetermined content of a predetermined number of terminal devices on a predetermined number of second display regions. Examples of the predetermined content include advertising content and program content.

The display control unit causes the predetermined content and the viewer-captured images of the predetermined number of terminal devices to be displayed on a display panel based on the display data received by the display data receiving unit. For example, the predetermined number of terminal devices are terminal devices which are selected from among a plurality of terminal devices based on the viewer number information of the predetermined content of the plurality of terminal devices in the server device. For example, the predetermined number of terminal devices are selected in the descending order of the number of viewers. In this case, for example, the predetermined content is displayed on the center of the screen, and the viewer-captured images of the predetermined number of terminal devices are displayed around the predetermined content.

As described above, in the invention, the predetermined content and the viewer-captured images of the predetermined number of terminal devices are displayed on the display panel. Thus, even when a few people view the predetermined content around the viewer, due to the viewers in the viewer-captured images of the predetermined number of terminal devices, the viewer viewing the predetermined content has sympathy, gets interested in, and is easily drawn to the predetermined content. Thus, for example, when the predetermined content is advertising content, the advertising effect is improved.

Further, in the invention, for example, there may be further provided a camera that captures a viewer of the predetermined content during a period of time in which the predetermined content is displayed on the display panel and a transmitting unit that transmits at least viewer-captured image data obtained by the camera to the server device. In this case, its own viewer-captured image can be a candidate of the viewer-captured image which is selected in the server device and displayed on the predetermined number of second display regions.

Further, in the invention, for example, there may be further provided an image data processing unit that processes the viewer-captured image data captured and obtained by the camera, and acquires viewer number information, and the transmitting unit may transmit the viewer-captured image data captured and obtained by the camera and the viewer number information acquired by the image data processing unit to the server device. In this case, the server device need not perform the process of acquiring the viewer number information on the viewer-captured image data, and thus the processing load is reduced.

Further, in the invention, for example, there may be further provided an information request receiving unit that receives an information request including content specifying information from the server device, and when information request receiving unit receives the information request, the camera may capture a viewer of the predetermined content during a period of time in which the predetermined content specified by the content specifying information included in the information request is displayed on the display panel, and the transmitting unit may transmit the viewer-captured image data obtained by the camera to the server device. Thus, the viewer-captured image data of certain content required by the server device is transmitted to the server device. In this case, the viewer number information may be transmitted together with the viewer-captured image data.

Another concept of the present invention lies in

a server device, including:

a receiving unit that receives viewer-captured image data captured and obtained by a camera during a display period of time of predetermined content from a plurality of terminal devices;

a viewer number information acquiring unit that acquires viewer number information of the predetermined content of the plurality of terminal devices;

a ranking information generating unit that values a terminal device having many viewers into a high ranking based on the viewer number information of the plurality of terminal devices acquired by the viewer number information acquiring unit, and generates ranking information of the plurality of terminal devices;

a display data generating unit that generates display data including content data for displaying the predetermined content on a first display region and viewer-captured image data for displaying viewer-captured images of a predetermined number of terminal devices selected from among the plurality of terminal devices based on the ranking information generated by the ranking information generating unit on a predetermined number of second display regions, the viewer-captured image data being received by the receiving unit; and

a display data transmitting unit that transmits the display data generated by the display data generating unit to the terminal device.

In the invention, the receiving unit receives viewer-captured image data captured and obtained by a camera during a display period of time of predetermined content from a plurality of terminal devices. The viewer number information acquiring unit acquires viewer number information of the predetermined content of the plurality of terminal devices. For example, the viewer number information acquiring unit receives the viewer number information from the plurality of terminal devices, and acquires the viewer number information of the predetermined content of the plurality of terminal devices. Further, for example, the viewer number information acquiring unit processes the viewer-captured image data of the plurality of terminal devices received by the receiving unit, and acquires the viewer number information of the predetermined content of the plurality of terminal devices.

The ranking information generating unit values a terminal device having many viewers into a high ranking based on the viewer number information of the plurality of terminal devices acquired by the viewer number information acquiring unit, and generates ranking information of the plurality of terminal devices. The display data generating unit generates display data to be transmitted to a plurality of terminal devices.

The display data includes content data for displaying the predetermined content on a first display region and viewer-captured image data for displaying viewer-captured images of a predetermined number of terminal devices selected from among the plurality of terminal devices based on the ranking information generated by the ranking information generating unit on a predetermined number of second display regions, the viewer-captured image data being received by the receiving unit. For example, the predetermined number of terminal devices are selected in the descending order of the number of viewers.

In this case, the viewer-captured image data of the predetermined number of terminal devices may be commonly included in the display data to be transmitted to each terminal device. However, the display data to be transmitted to each terminal device may be generated such that the viewer-captured image data of the terminal device serving as the transmission destination is not included in the viewer-captured image data of the predetermined number of terminal devices.

For example, the display data is generated using a display template. The display data is generated such that content data and image data are arranged on the display template. For example, the display template is configured such that the first display region is positioned on the screen center, and a predetermined number of second display regions are positioned around the first display region.

The display data transmitting unit transmits the display data generated by the display data generating unit to the terminal device. The terminal device is not limited to a plurality of terminal devices that transmit the viewer-captured image data of the predetermined content, and may include any other terminal device.

As described above, in the invention, the predetermined content and the display data for displaying the viewer-captured images of the predetermined number of terminal devices are transmitted to the terminal device, and the predetermined content and the viewer-captured images of the predetermined number of terminal devices are displayed on the display panel. Thus, even when a few people view the predetermined content around the viewer, due to the viewers in the viewer-captured images of the predetermined number of terminal devices, the viewer viewing the predetermined content has sympathy, gets interested in, and is easily drawn to the predetermined content. Thus, for example, when the predetermined content is advertising content, the advertising effect is improved.

Further, in the invention, for example, there may be further provided an information request transmitting unit that transmits an information request including content specifying information to the plurality of terminal devices, the receiving unit may receive the viewer-captured image data of the predetermined content transmitted from the plurality of terminal devices according to transmission of the information request by the information request transmitting unit, and the viewer number information acquiring unit may acquire the viewer number information of the predetermined content of the plurality of terminal devices according to transmission of the information request by the information request transmitting unit. Thus, viewer-captured image data of certain content can be received from a plurality of terminal devices, the corresponding viewer number information can be acquired, and the display data to be transmitted to each terminal device can be updated.

A concept of the present invention lies in

a terminal device, including:

a ranking information receiving unit that receives ranking information of a plurality of terminal devices obtained by valuing a terminal device having many viewers into a high ranking based on viewer number information of predetermined content of the plurality of terminal devices from a server device;

an image data acquiring unit that acquires viewer-captured image data of a predetermined number of terminal devices selected based on the ranking information of the plurality of terminal devices received by the ranking information receiving unit;

a display data generating unit that generates display data including content data for displaying the predetermined content on a first display region and viewer-captured image data for displaying viewer-captured images of a predetermined number of terminal devices on a predetermined number of second display regions, respectively, the viewer-captured image data being acquired by the image data acquiring unit; and

a display control unit that causes the predetermined content and the viewer-captured image of the predetermined number of imaging devices to be displayed on a display panel based on the display data generated by the display data generating unit.

In the invention, the ranking information receiving unit receives ranking information of a plurality of terminal devices obtained by valuing a terminal device having many viewers into a high ranking based on viewer number information of predetermined content of the plurality of terminal devices from a server device. For example, the predetermined content is advertising content or program content. The image data acquiring unit selects a predetermined number of terminal devices based on the ranking information received by the ranking information receiving unit. For example, the predetermined number of terminal devices are selected in the descending order of the number of viewers. In this case, its own location terminal may not be included in the predetermined number of location terminals.

The image data acquiring unit acquires the viewer-captured image data of the predetermined number of terminal devices at the display timing of the predetermined content. When its own terminal device is included in the predetermined number of terminal devices, the camera enters the viewer capturing state, and the live viewer-captured image data is obtained. Further, regarding another terminal device included in the predetermined number of terminal devices, access to the corresponding terminal device is made, and live viewer-captured image data is received from the corresponding terminal device.

The display data generating unit generates the display data at the display timing of the predetermined content. The display data includes content data for displaying the predetermined content on a first display region and viewer-captured image data (the live viewer-captured image data) for displaying viewer-captured images of a predetermined number of terminal devices selected based on the ranking information of the plurality of terminal devices as described above on a predetermined number of second display regions, respectively, the viewer-captured image data being acquired by the image data acquiring unit.

For example, the display data is generated using a display template. The display data is generated such that content data and image data are arranged on the display template. For example, the display template is configured such that the first display region is positioned on the screen center, and a predetermined number of second display regions are positioned around the first display region. The content data for displaying the predetermined content is delivered in advance independently or through an arrangement on the display template.

The display control unit causes the predetermined content and the viewer-captured image (the live viewer captured image) of the predetermined number of imaging devices to be displayed on a display panel based on the display data generated by the display data generating unit. In this case, for example, the predetermined content is displayed on the center of the screen, and the viewer-captured images of the predetermined number of terminal devices are displayed around the predetermined content.

As described above, in the invention, the display panel displays the predetermined content and the live viewer-captured images of the predetermined number of terminal devices selected based on the ranking information of the number of viewers of the predetermined content of the plurality of terminal devices. Thus, even when a few people view the predetermined content around the viewer, due to the viewers in the viewer-captured images of the predetermined number of terminal devices, the viewer viewing the predetermined content has sympathy, gets interested in, and is easily drawn to the predetermined content. Thus, for example, when the predetermined content is advertising content, the advertising effect is improved.

In the invention, for example, there may be further provided a camera that captures a viewer of the predetermined content during a period of time in which the predetermined content is displayed on the display panel and a transmitting unit that transmits viewer-captured image data captured and obtained by the camera to the server device. In this case, its own terminal device can be a target of ranking based on the number of viewers in the server device.

In the invention, for example, there may be further provided a camera that captures a viewer of the predetermined content during a period of time in which the predetermined content is displayed on the display panel, an image data processing unit that processes viewer-captured image data captured and obtained by the camera and acquires viewer number information, and a transmitting unit that transmits the viewer-captured image data obtained by the image data processing unit to the server device. In this case, its own terminal device can be a target of ranking based on the number of viewers in the server device. In this case, the server device need not perform the process of acquiring the viewer number information on the viewer-captured image data, and thus the processing load is reduced.

A concept of the invention lies in

a server device, including:

a viewer number information acquiring unit that acquires viewer number information of predetermined content of a plurality of terminal devices;

a ranking information generating unit that values a terminal device having many viewers into a high ranking based on the viewer number information of the plurality of terminal devices acquired by the viewer number information acquiring unit, and generates ranking information of the plurality of terminal devices; and

a ranking information transmitting unit that transmits the ranking information generated by the ranking information generating unit to the terminal device.

In the invention, the viewer number information acquiring unit acquires viewer number information of predetermined content of a plurality of terminal devices. For example, the viewer number information acquiring unit receives the viewer number information from the plurality of terminal devices, and acquires the viewer number information of the predetermined content of the plurality of terminal devices. Further, for example, there may be further provided a receiving unit that receives viewer-captured image data captured and obtained by a camera at a display period of time of the predetermined content from the plurality of terminal devices, and the viewer number information acquiring unit may process the viewer-captured image data of the plurality of terminal devices received by the receiving unit, and acquires the viewer number information of the predetermined content of the plurality of terminal devices.

The ranking information generating unit values a terminal device having many viewers into a high ranking based on the viewer number information of the plurality of terminal devices acquired by the viewer number information acquiring unit, and generates ranking information of the plurality of terminal devices. The ranking information transmitting unit transmits the ranking information generated by the ranking information generating unit to the terminal device. The terminal device is not limited to a plurality of terminal devices that get the viewer number information of the predetermined content, and may include any other terminal device.

As described above, in the invention, the ranking information of the number of viewers of the predetermined content of the plurality of terminal devices is transmitted to the terminal device. Thus, the terminal device displays the predetermined content and the live viewer-captured images of the predetermined number of terminal devices selected based on the ranking information through the display panel. Thus, even when a few people view the predetermined content around the viewer, due to the viewers in the viewer-captured images of the predetermined number of terminal devices, the viewer viewing the predetermined content has sympathy, gets interested in, and is easily drawn to the predetermined content. Thus, for example, when the predetermined content is advertising content, the advertising effect is improved.

Further, a concept of the invention lies in

a network system that includes a server device and a terminal device which are connected to each other via a network, the network system including

the server device including

a receiving unit that receives viewer-captured image data captured and obtained by a camera during a display period of time of predetermined content from a plurality of terminal devices,

a viewer number information acquiring unit that acquires viewer number information of the predetermined content of the plurality of terminal devices,

a ranking information generating unit that values a terminal device having many viewers into a high ranking based on the viewer number information of the plurality of terminal devices acquired by the viewer number information acquiring unit, and generates ranking information of the plurality of terminal devices,

a display data generating unit that generates display data including content data for displaying the predetermined content on a first display region and viewer-captured image data for displaying viewer-captured images of a predetermined number of terminal devices selected from among the plurality of terminal devices based on the ranking information generated by the ranking information generating unit on a predetermined number of second display regions, the viewer-captured image data being received by the receiving unit, and

a display data transmitting unit that transmits the display data generated by the display data generating unit to the terminal device; and

the terminal device including

a display data receiving unit that receives the display data from the server device,

a display control unit that causes the predetermined content and the viewer-captured images of the predetermined number of terminal devices to be displayed on a display panel based on the display data received by the display data receiving unit.

Further, another concept of the invention lies in

a network system that includes a server device and a terminal device which are connected to each other via a network, the network system including:

the server device including

a viewer number information acquiring unit that acquires viewer number information of predetermined content of a plurality of terminal devices,

a ranking information generating unit that values a terminal device having many viewers into a high ranking based on the viewer number information of the plurality of terminal devices acquired by the viewer number information acquiring unit, and generates ranking information of the plurality of terminal devices, and

a ranking information transmitting unit that transmits the ranking information generated by the ranking information generating unit to the terminal device; and

the terminal device including

a ranking information receiving unit that receives the ranking information of the plurality of terminal devices from the server device,

an image data acquiring unit that acquires viewer-captured image data of a predetermined number of terminal devices selected based on the ranking information of the plurality of terminal devices received by the ranking information receiving unit,

a display data generating unit that generates display data including content data for displaying the predetermined content on a first display region and viewer-captured image data for displaying viewer-captured images of a predetermined number of terminal devices on a predetermined number of second display regions, respectively, the viewer-captured image data being acquired by the image data acquiring unit, and

a display control unit that causes the predetermined content and the viewer-captured image of the predetermined number of imaging devices to be displayed on a display panel based on the display data generated by the display data generating unit.

### Effects of the Invention

According to the invention, predetermined content and viewer-captured images of a predetermined number of terminal devices are displayed on a display panel of a terminal device. Thus, even when a few people view the predetermined content around the viewer, due to the viewers in the viewer-captured images of the predetermined number of terminal devices, the viewer viewing the predetermined content has sympathy, gets interested in, and is easily drawn to the predetermined content. Thus, for example, when the predetermined content is advertising content, the advertising effect is improved.

### BRIEF DESCRIPTION OF DRAWINGS

FIG. 1 is a block diagram illustrating a configuration example of a signage system according to a first embodiment.

FIG. 2 is a diagram illustrating an example display template.

FIG. 3 is a diagram illustrating an example of viewer-captured images obtained by location terminals in stores in main cities of Japan.

FIG. 4 is a diagram illustrating a display example in a location terminal installed in a store in Sapporo.

FIG. 5 is a block diagram illustrating a configuration example of a location terminal.

FIG. 6 is a functional block diagram illustrating main functions of a location terminal.

FIG. 7 is a block diagram illustrating a configuration example of a center server.

FIG. 8 is a functional block diagram illustrating of main functions of a center server.

FIG. 9 is a sequence diagram schematically illustrating exchange of data or information between a center server and a location terminal.

FIG. 10 is a flowchart illustrating a transmission process procedure of viewer-captured image data and viewer number information in a location terminal.

FIG. 11 is a flowchart illustrating a transmission process procedure of display data in a center server.

FIG. 12 is a flowchart illustrating a reception process procedure of display data in a location terminal.

FIG. 13 is a flowchart illustrating a display process procedure of predetermined advertising content in a location terminal.

FIG. 14 is a diagram illustrating an example of a method of displaying content A in a location terminal according to an embodiment.

FIG. 15 is a diagram illustrating an example of a method of displaying content A in a location terminal according to a related art.

FIG. 16 is a functional block diagram illustrating main functions of a location terminal.

FIG. 17 is a flowchart illustrating a transmission process procedure of viewer-captured image data in a location terminal.

FIG. 18 is a functional block diagram illustrating of main functions of a center server.

FIG. 19 is a flowchart illustrating a transmission process procedure of display data in a center server.

FIG. 20 is a functional block diagram illustrating main functions of a location terminal.

FIG. 21 is a functional block diagram illustrating of main functions of a center server.

FIG. 22 is a sequence diagram schematically illustrating exchange of data or information between a center server and a location terminal.

FIG. 23 is a flowchart illustrating a transmission process procedure of viewer number information in a location terminal.

FIG. 24 is a flowchart illustrating a transmission process procedure of ranking information in a center server.

FIG. 25 is a flowchart illustrating a reception process procedure of ranking information in a location terminal.

FIG. 26 is a flowchart illustrating a display process procedure of predetermined advertising content in a location terminal.

FIG. 27 is a functional block diagram illustrating main functions of a location terminal.

FIG. 28 is a functional block diagram illustrating of main functions of a center server.

FIG. 29 is a flowchart illustrating a transmission process procedure of display data in a center server.

### MODE FOR CARRYING OUT THE INVENTION

Hereinafter, a mode of embodying the invention (hereinafter, referred to as an “embodiment”) will be described. The description will proceed in the following order.

1. Embodiment

2. Modified Examples

### 1. Embodiment

[Configuration Example of Signage System]

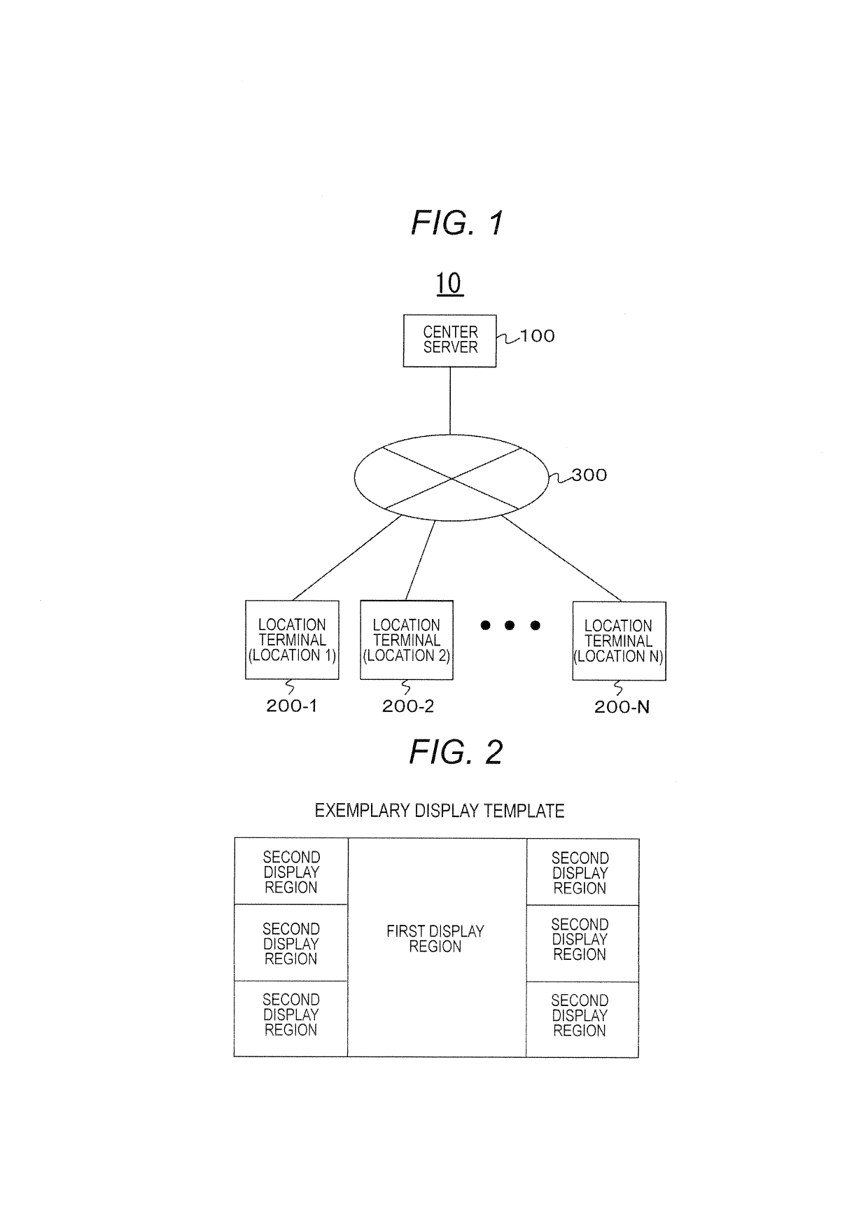

FIG. 1 illustrates a configuration example of a signage system (network system) 10 according to an embodiment. The signage system 10 is a signage system in a store such as a supermarket.

The signage system 10 is configured such that a center server (server device) 100 is connected with N (N is an integer of 2 or more) location terminals (terminal devices) 200-1 to 200-N via a network 300. The center server 100 is installed in a head office, and the location terminals (terminal devices) 200-1 to 200-N are installed in respective stores. The location terminals 200-1 to 200-N display advertising content delivered from the center server 100 according to scheduling at a predetermined timing.

In this embodiment, the center server 100 transmits an information request including content specifying information to the location terminals 200-1 to 200-N. The location terminals 200-1 to 200-N receive the information request transmitted from the center server 100. The location terminals (terminal devices) 200-1 to 200-N capture the viewer of predetermined advertising content specified by the content specifying information according to the information request. In this case, in the location terminals 200-1 to 200-N, the viewer of the predetermined advertising content is captured by a camera installed, for example, at an upper end of the display panel during a period of time in which the predetermined advertising content is displayed on the display panel, for example, during 30 seconds or 1 minute.

The viewer-captured image data (video data) obtained by the location terminals 200-1 to 200-N is transmitted to the center server 100. Further, the location terminals 200-1 to 200-N process the viewer-captured image data and acquire viewer number information. The process of acquiring the viewer number information will not be described in detail but may be performed using a facial image recognition technique disclosed in Japanese Patent Application Laid-Open No. 2008-112401, for example.

In the display period of time of the predetermined advertising content, the viewer who views the predetermined advertising content is expected to change. For this reason, for example, the number of viewers of each of predetermined pieces of frame image data extracted from the viewer-captured image data at predetermined time intervals in the display period of time of the predetermined advertising content is obtained, and an average number of viewers is regarded as a final viewer number. The viewer number information obtained by the location terminals 200-1 to 200-N is transmitted to the center server 100.

The center server 100 receives the viewer-captured image data and the viewer number information of the predetermined advertising content transmitted from the location terminals 200-1 to 200-N. The center server 100 values the location terminal having many viewers among the location terminals 200-1 to 200-N into a high ranking based on the viewer number information, and generates ranking information of the location terminals 200-1 to 200-N.

The center server 100 generates display data to be transmitted to the location terminals 200-1 to 200-N based on the ranking information. The display data includes content data for displaying the predetermined advertising content on a first display region and the viewer-captured image data of a predetermined number of location terminals for displaying the viewer-captured image on a predetermined number of second display regions. The predetermined number of location terminals are selected from among the location terminals 200-1 to 200-N based on the ranking information. For example, the predetermined number of location terminals are selected in the descending order of the number of viewers.

In this case, the viewer-captured image data of the predetermined number of location terminals are commonly included in the display data to be transmitted to the location terminals 200-1 to 200-N. Alternatively, the display data to be transmitted to the location terminals 200-1 to 200-N is generated so that the viewer-captured image data of the location terminal serving as the transmission destination is not included in the viewer-captured image data of the predetermined number of location terminals.

In the center server 100, for example, a display template is used to generate the display data. The display data is generated such that content data and image data are arranged on the display template. For example, the display template is configured such that the first display region is positioned at the screen center, and the predetermined number of second display regions are positioned around the first display region.

FIG. 2 illustrates an example of the display template in which six second display regions are disposed. The content data arranged on the first display region and the viewer-captured image data arranged on the second display region are subjected to an appropriate scaling process, and have the display resolution adjusted to fit each region.

The display image data obtained by the center server 100 is supplied to the location terminals 200-1 to 200-N. The location terminals 200-1 to 200-N receive the display data of the predetermined advertising content transmitted from the center server 100. Then, the location terminals 200-1 to 200-N perform a display on the display panel based on the display data at a display timing of the predetermined advertising content. In other words, the display panel displays the viewer-captured image of the predetermined advertising content in the predetermined number of location terminals together with the predetermined advertising content.

As described above, the center server 100 selects the predetermined number of location terminals in the descending order of the number of viewers based on the ranking information of the location terminals 200-1 to 200-N. Thus, the viewer-captured image of the predetermined number of location terminals displayed on the display panel includes relatively many viewers.

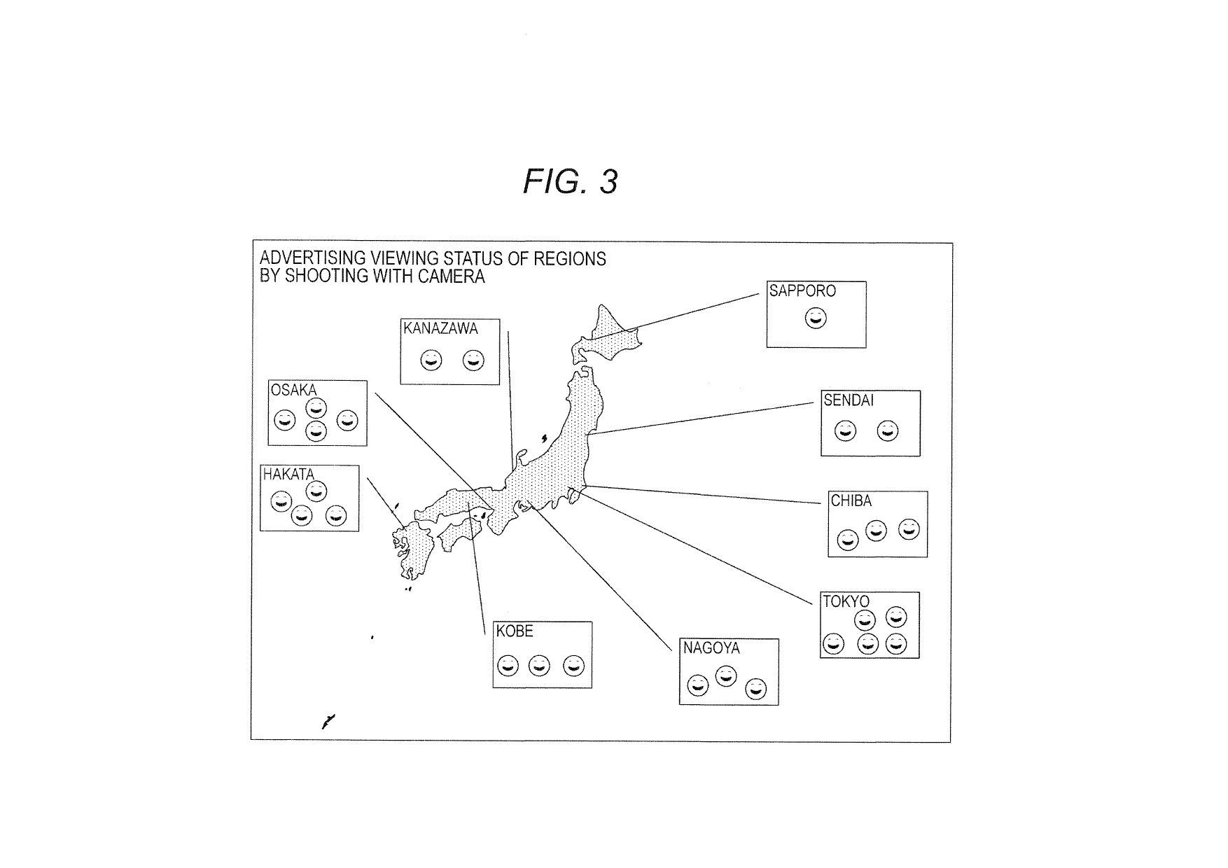

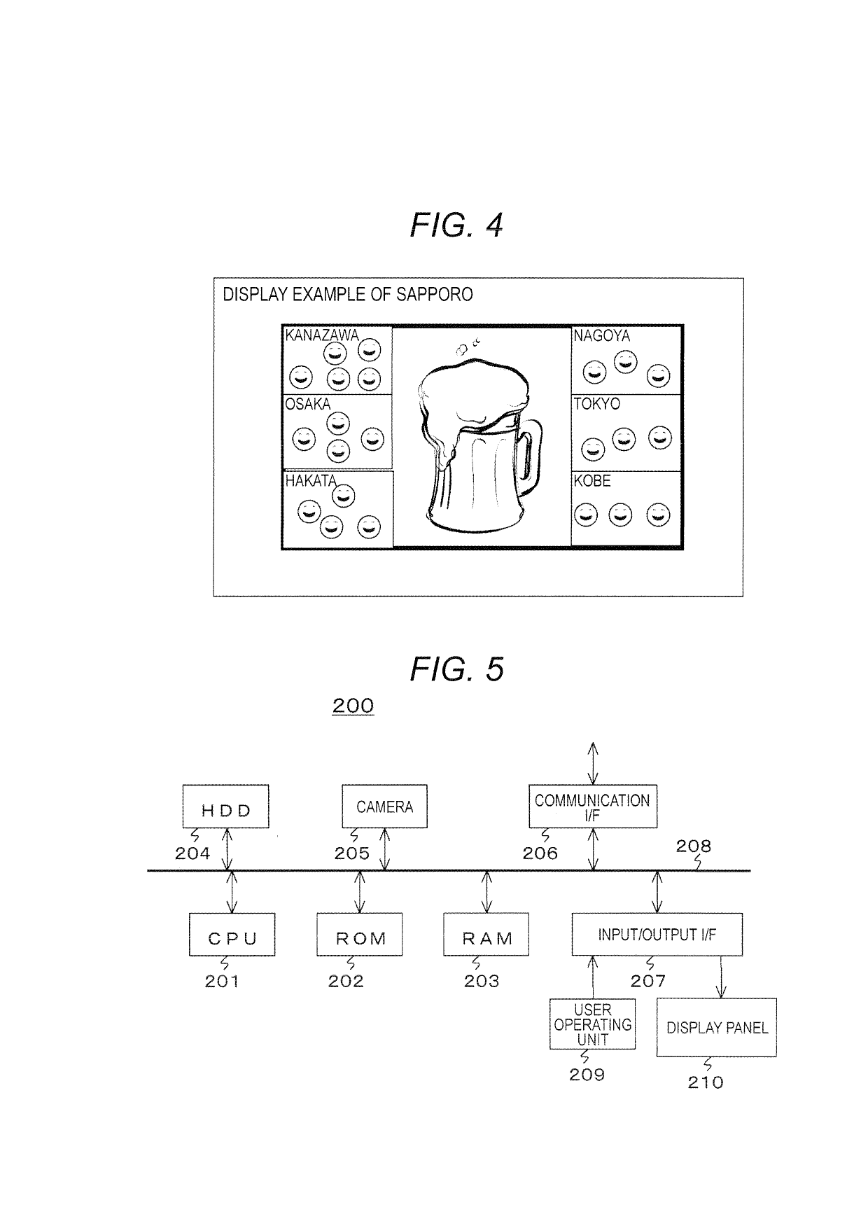

FIG. 3 illustrates an example of the viewer-captured images obtained by location terminals in stores in main cities of Japan. In this example, in order to help with understanding, a viewer included in a captured image is represented by illustration. For example, FIG. 4 illustrates a display example in a location terminal installed in a store in Sapporo in the case of the example of FIG. 3. Advertising content of “beer” is displayed on the first display region, and viewer-captured images obtained by location terminals in stores in cities having many viewers such as “Tokyo,” “Osaka,” “Hakata,” “Nagoya,” “Chiba,” and “Kobe” are displayed on the six second display regions.

[Configuration Example of Location Terminal]

FIG. 5 illustrates a configuration example of a location terminal 200 (200-1 to 200-N). The location terminal 200 includes a CPU 201, a ROM 202, a RAM 203, a HDD (hard disk drive) 204, and a camera 205. The location terminal 200 further includes a communication interface (I/F) 206, an input output (IO) interface (I/F) 207, an internal bus 208, a user operating unit 209, and a display panel 210.

The CPU 201 controls operations of components of the location terminal 200. The ROM 202 stores a processing program of the CPU 201 and the like. The RAM 203 functions as a work area of the CPU 201. The CPU 201 reads the processing program stored in the ROM 202 as necessary, transfers the read processing program to be developed in the RAM 203, reads the developed processing program, and executes processing.

The CPU 201, the ROM 202, the RAM 203, the HDD 204, the camera 205, the communication I/F 206, and the IO I/F 207 are connected to the internal bus 208. The user operating unit 209 and the display panel 210 are connected to the IO I/F 207. The user operating unit 209 and the display panel 210 configure a user interface. The user operating unit 209 includes a keyboard, a mouse, and the like. For example, the display panel 210 is configured with a flat panel display such as an LCD (liquid crystal display).

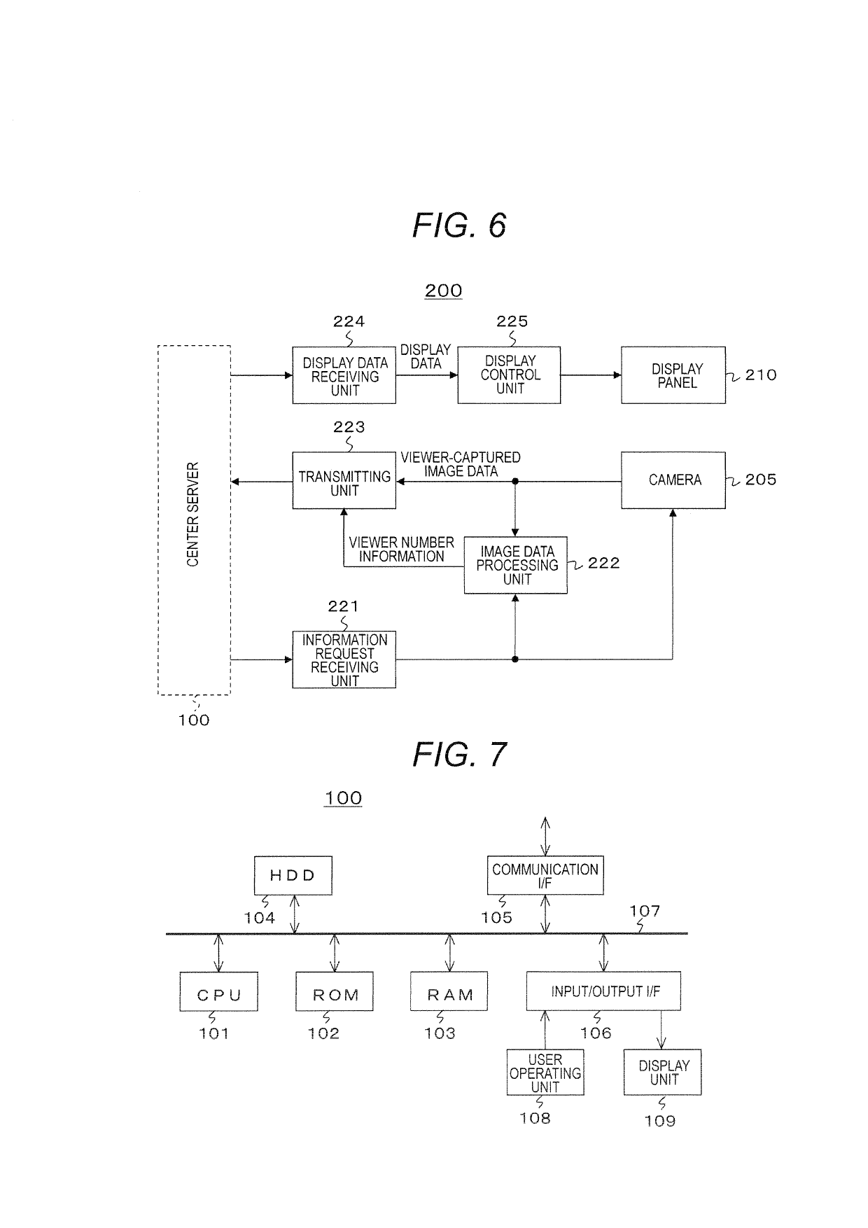

FIG. 6 is a functional block diagram illustrating main functions of the location terminal 200. The location terminal 200 includes an information request receiving unit 221, an image data processing unit 222, a transmitting unit 223, a display data receiving unit 224, and a display control unit 225 in addition to the camera 205 and the display panel 210. The information request receiving unit 221 receives the information request including the content specifying information transmitted from the center server 100.

The camera 205 captures the viewer during a period of time in which the predetermined advertising content specified by the content specifying information included in the information request received by the information request receiving unit 221 is displayed on the display panel 210, and obtains the viewer-captured image data. The image data processing unit 222 processes the viewer-captured image data of the predetermined advertising content obtained by the camera 205, and acquires the viewer number information. The transmitting unit 223 transmits the viewer-captured image data of the predetermined advertising content obtained by the camera 205 and the viewer number information of the predetermined advertising content acquired by the image data processing unit 222 to the center server 100.

The display data receiving unit 224 receives the display data of the predetermined advertising content transmitted from the center server 100. The display control unit 225 causes the predetermined advertising content and the viewer-captured images of the predetermined number of location terminals to be displayed on the display panel 210 based on the display data received by the display data receiving unit 224 at the display timing of the predetermined advertising content. The information request receiving unit 221, the transmitting unit 223, and the display data receiving unit 224 are implemented by the communication interface 206. The image data processing unit 222 and the display control unit 225 are implemented by the CPU 201.

[Configuration Example of Center Server]

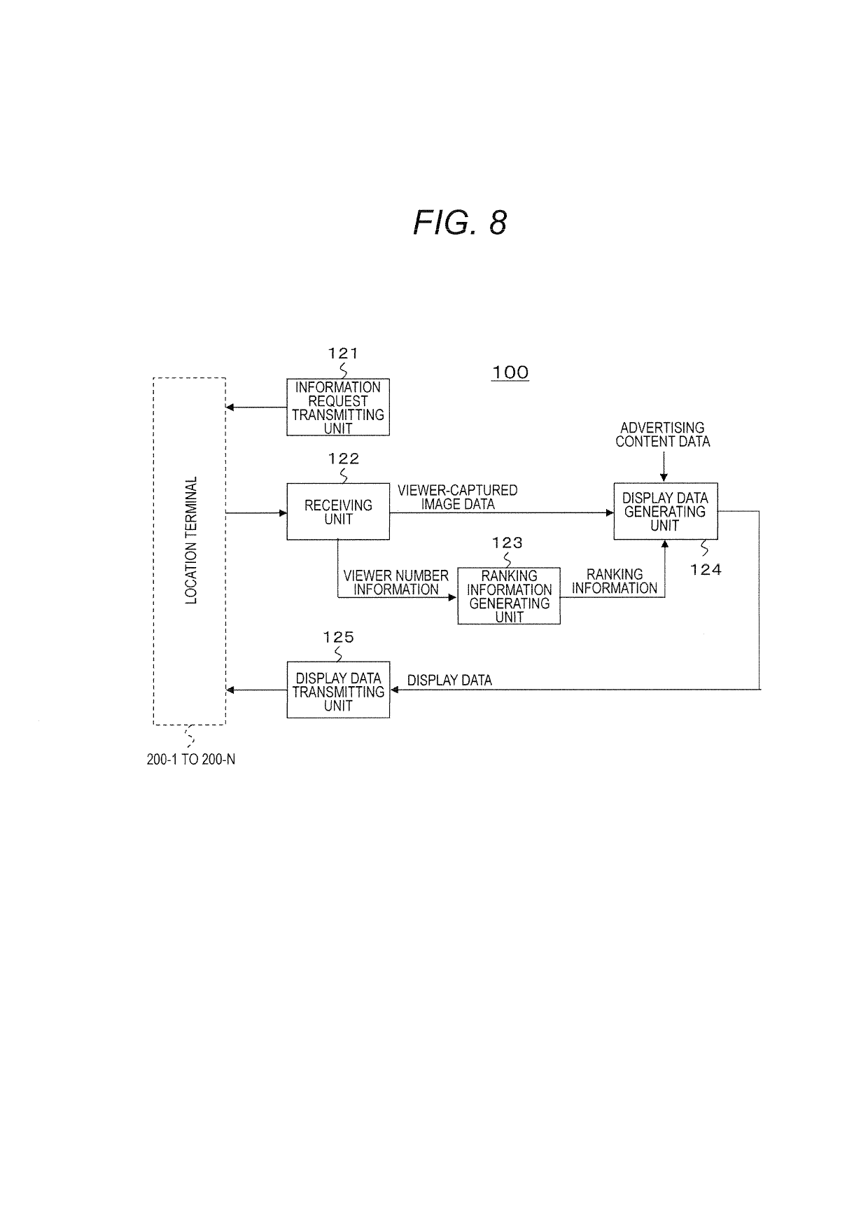

FIG. 7 illustrates a configuration example of the center server 100. The center server 100 includes a CPU 101, a ROM 102, a RAM 103, and a HDD (hard disk drive) 104. The center server 100 further includes a communication interface (I/F) 105, an IO interface (I/F) 106, an internal bus 107, a user operating unit 108, and a display unit 109.

The CPU 101 controls operations of components of the center server 100. The ROM 102 stores a processing program of the CPU 101 and the like. The RAM 103 functions as a work area of the CPU 101. The CPU 101 reads the processing program stored in the ROM 102 as necessary, transfers the read processing program to be developed in the RAM 103, reads the developed processing program, and executes processing.

The CPU 101, the ROM 102, the RAM 103, the HDD 104, the communication I/F 105, and the IO I/F 106 are connected to the internal bus 107. The user operating unit 108 and the display unit 109 are connected to the IO I/F 106. The user operating unit 108 and the display unit 109 configure the user interface. The user operating unit 108 includes a keyboard, a mouse, and the like. For example, the display unit 109 is configured with a flat panel display such as an LCD (liquid crystal display).

FIG. 8 is a functional block diagram illustrating main functions of the center server 100. The center server 100 includes an information request transmitting unit 121, a receiving unit 122, a ranking information generating unit 123, a display data generating unit 124, and a display data transmitting unit 125. The information request transmitting unit 121, the receiving unit 122 and the display data transmitting unit 125 are implemented by the communication interface 105. The ranking information generating unit 123 and the display data generating unit 124 are implemented by the CPU 101. The information request transmitting unit 121 transmits the information request including the content specifying information to the location terminals 200-1 to 200-N.

The receiving unit 122 receives the viewer-captured image data and the viewer number information of the predetermined advertising content transmitted from the location terminals 200-1 to 200-N. The ranking information generating unit 123 generates the ranking information of the location terminals 200-1 to 200-N based on the viewer number information of the location terminals 200-1 to 200-N received by the receiving unit 122. In this case, the ranking information generating unit 123 values the location terminal having many viewers into a high ranking.

The display data generating unit 124 generates the display data to be transmitted to the location terminals 200-1 to 200-N based on the ranking information generated by the ranking information generating unit 123. The display data includes content data for displaying the predetermined advertising content on the first display region and a predetermined number of viewer-captured image data for displaying the viewer-captured images on the predetermined number of second display regions. The predetermined pieces of viewer-captured image data are the viewer-captured image data which is used to display viewer-captured images of a predetermined number of location terminals selected from among the location terminals 200-1 to 200-N based on the ranking information and received by the receiving unit 122. For example, the predetermined number of location terminals are selected in the descending order of the number of viewers. The display data transmitting unit 125 transmits the display data generated by the display data generating unit 124 to the location terminals 200-1 to 200-N.

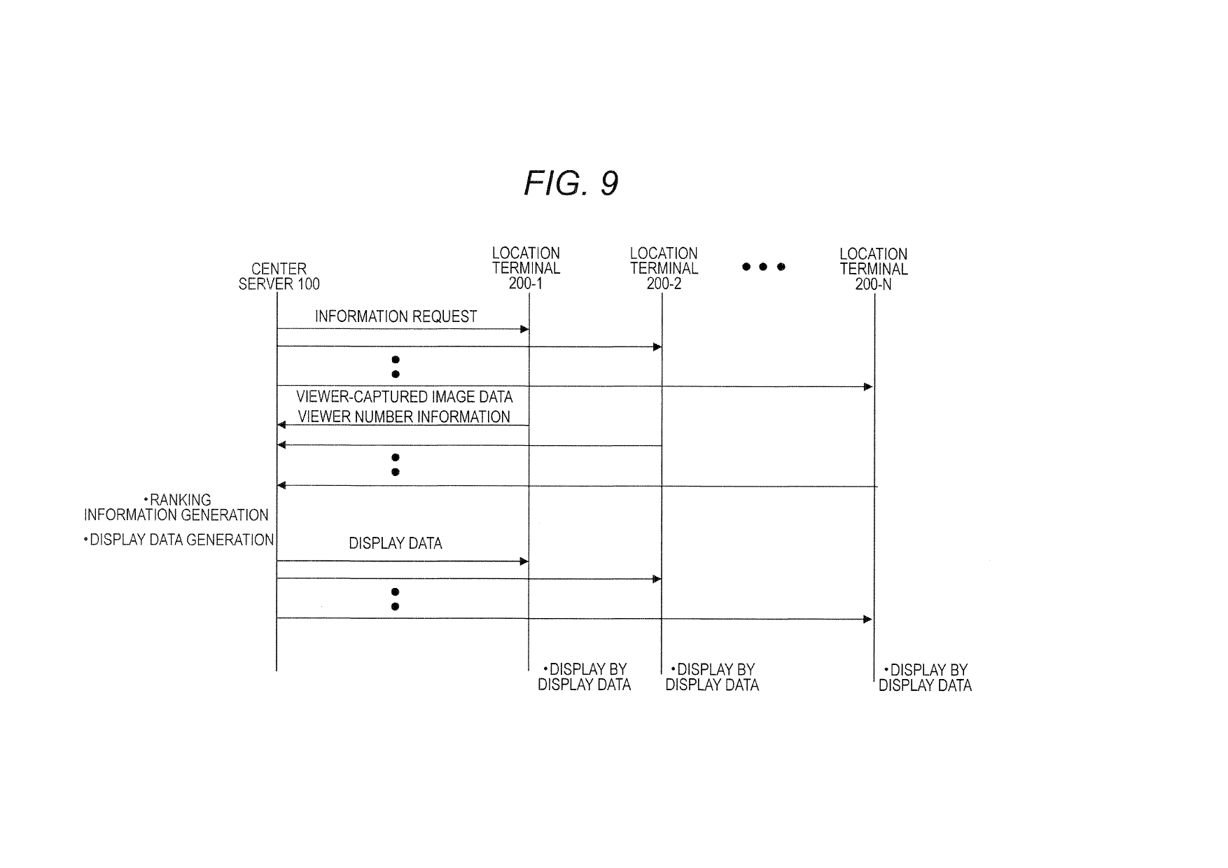

A sequence diagram of FIG. 9 schematically illustrates exchange of data or information between the center server 100 and the location terminals 200-1 to 200-N. First, the information request including the content specifying information is transmitted from the center server 100 to the location terminals 200-1 to 200-N. On the other hand, the viewer-captured image data and the viewer number information of the predetermined advertising content specified by the content specifying information are transmitted from the location terminals 200-1 to 200-N to the center server 100.

Thereafter, the center server 100 values a location terminal having many viewers into a high ranking based on the viewer number information of the location terminals 200-1 to 200-N, and generates the ranking information of the location terminals 200-1 to 200-N. Further, the center server 100 generates the display data to be transmitted to the location terminals 200-1 to 200-N based on the ranking information. The display data includes the content data for displaying the predetermined advertising content on the first display region and the image data for displaying the viewer-captured images of the predetermined number of location terminals selected based on the ranking information on the predetermined number of second display regions.

Thereafter, the display data generated as described above is transmitted from the center server 100 to the location terminals 200-1 to 200-N. The location terminals 200-1 to 200-N display the predetermined advertising content and the viewer-captured images of the predetermined number of location terminals through the display panel 210 based on the display data at the display timing of the predetermined advertising content (see FIG. 4).

[Process Procedures of Location Terminal and Center Server]

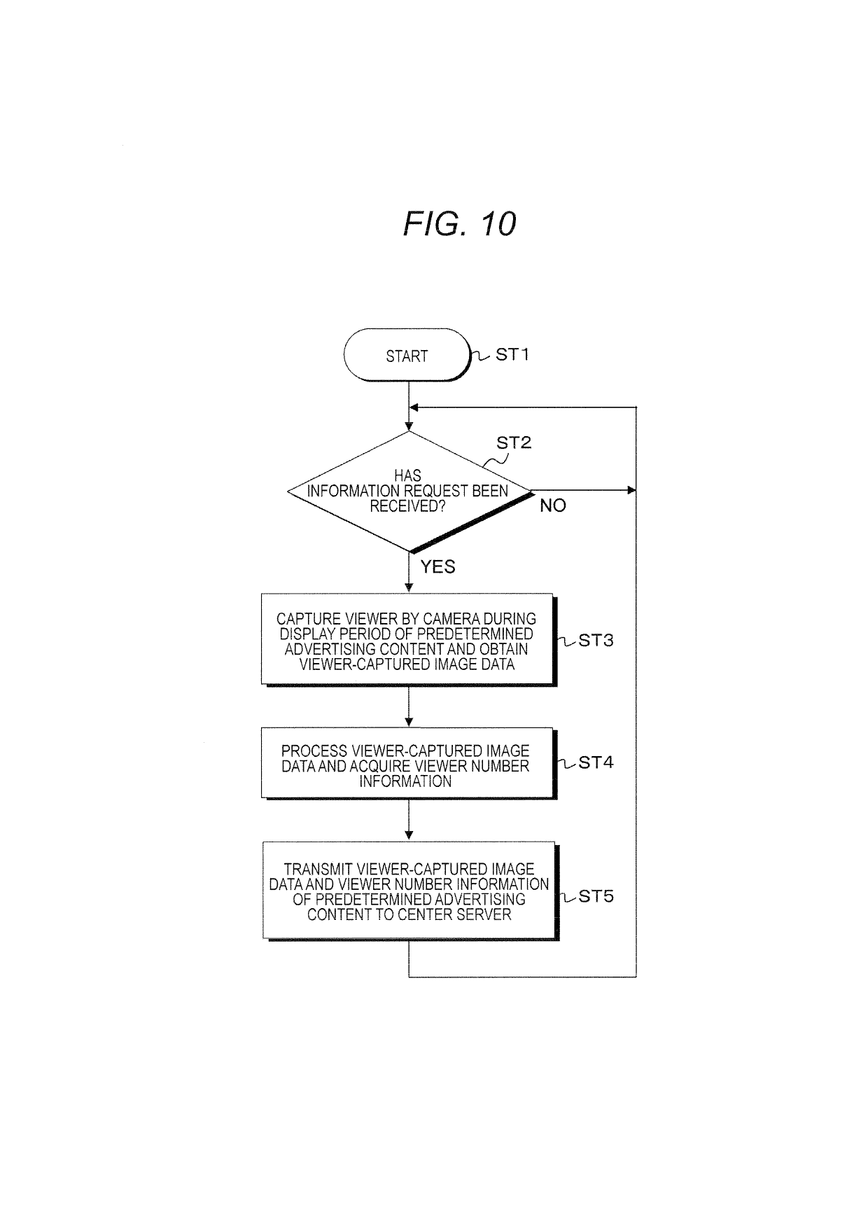

A flowchart of FIG. 10 illustrates a transmission process procedure of the viewer-captured image data and the viewer number information in the location terminal 200 (200-1 to 200-N). In step ST1, the location terminal 200 starts the process, and then causes the process to proceed to step ST2.

In step ST2, the location terminal 200 determines whether or not the information request including the content specifying information has been received from the center server 100. When it is determined that the information request has been received, the location terminal 200 causes the process to proceed to step ST3. In step ST3, the location terminal 200 captures the viewer through the camera 205 in a period of time in which the predetermined advertising content specified by the content specifying information included in the information request is displayed on the display panel 210, and acquires the viewer-captured image data.

Next, in step ST4, the location terminal 200 processes the viewer-captured image data obtained in step ST3, and acquires the viewer number information. Then, in step ST5, the location terminal 200 transmits the viewer-captured image data of the predetermined advertising content obtained in step ST3 and the viewer number information of the predetermined advertising content acquired in step ST4 to the center server 100. After the process of step ST5 ends, the location terminal 200 causes the process to return to step ST2.

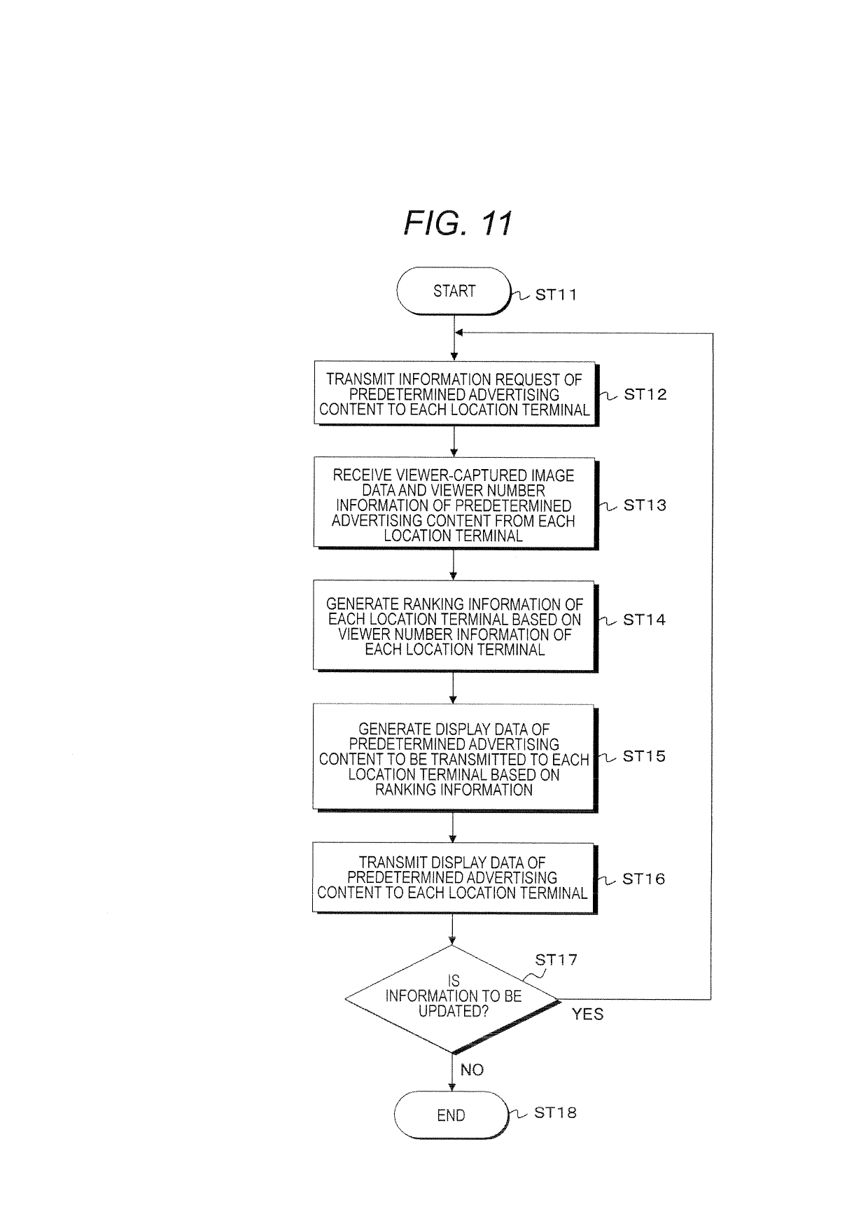

A flowchart of FIG. 11 illustrates a transmission process procedure of the display data in the center server 100. In step ST11, the center server 100 starts the process, and then causes the process to proceed to step ST12. In step ST12, the center server 100 transmits an information request including content information of predetermined advertising content to the location terminals 200-1 to 200-N.

Next, in step ST13, the center server 100 receives the viewer-captured image data and the viewer number information of the predetermined advertising content transmitted from the location terminals 200-1 to 200-N. Then, in step ST14, the center server 100 generates the ranking information of the location terminals 200-1 to 200-N based on the viewer number information of the location terminals 200-1 to 200-N received in step ST13. In this case, a location terminal having many viewers is valued into a high ranking.

Next, in step ST15, the center server 100 generates display data of the predetermined advertising content to be transmitted to the location terminals 200-1 to 200-N based on the ranking information. The center server 100 generates the display data, for example, using a display template. The display data includes a predetermined number of viewer-captured image data in addition to the content data for displaying the predetermined advertising content on the first display region. The predetermined pieces of viewer-captured image data are used to display viewer-captured images in a predetermined number of location terminals selected from among the location terminals 200-1 to 200-N based on the ranking information.

Next, in step ST16, the center server 100 transmits the display data generated in step ST15 to the location terminals 200-1 to 200-N. Then, after the process of step ST16 ends, in step ST17, the center server 100 determines whether or not information is to be updated. The user sets whether or not information is to be updated in advance. When it is determined that information is to be updated, the center server 100 causes the process to return to step ST12. However, when it is determined that information is not to be updated, in step ST18, the center server 100 ends the process.

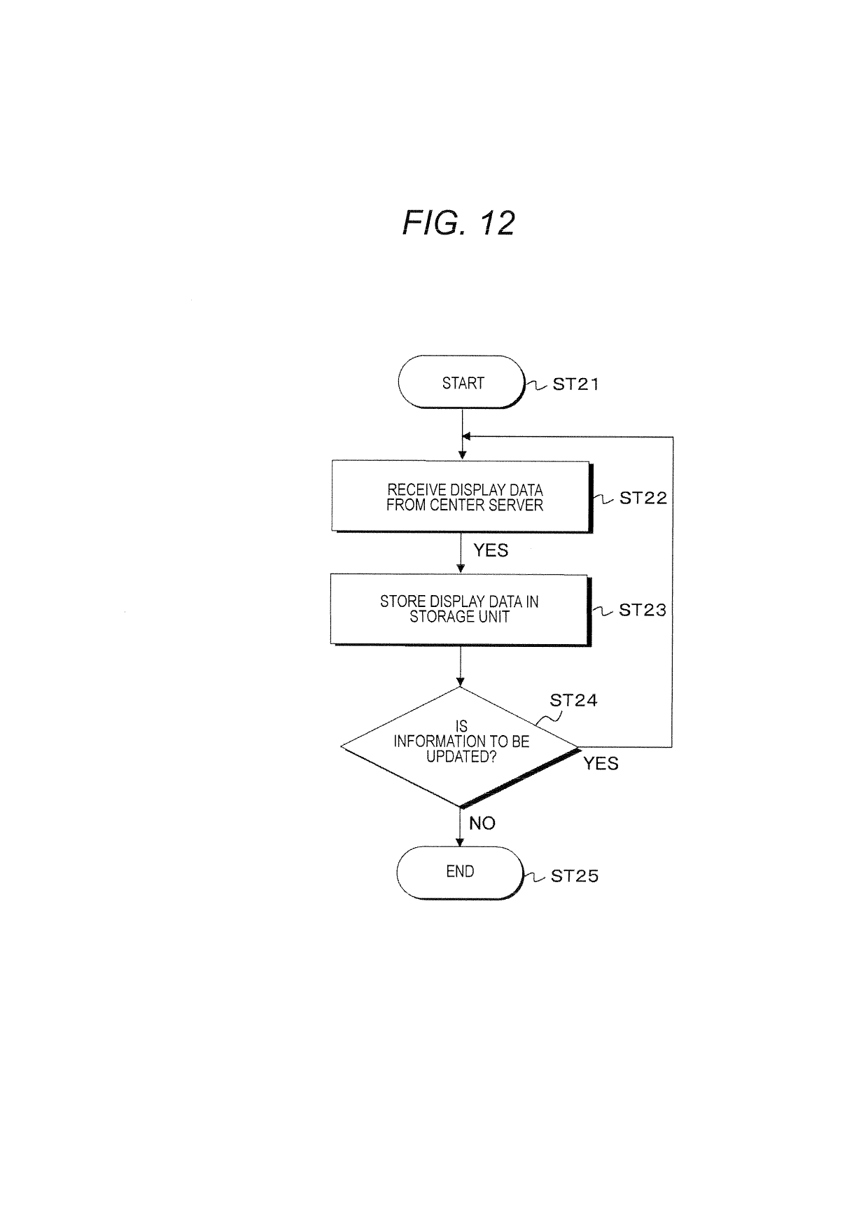

A flowchart of FIG. 12 illustrates a reception process procedure of the display data in the location terminal 200 (200-1 to 200-N). In step ST21, the location terminal 200 starts the process, and then causes the process to proceed to step ST22. In step ST22, the location terminal 200 receives the display data from the center server 100.

Next, in step the location terminal 200 stores the display data received in step ST22 in a storage unit such as a HDD. Then, after the process of step ST23, in step ST24, the location terminal 200 determines whether or not information is to be updated. The user sets whether or not information is to be updated in advance. When it is determined that information is to be updated, the location terminal 200 causes the process to return to step ST22. However, when it is determined that information is not to be updated, in step ST25, the location terminal 200 ends the process.

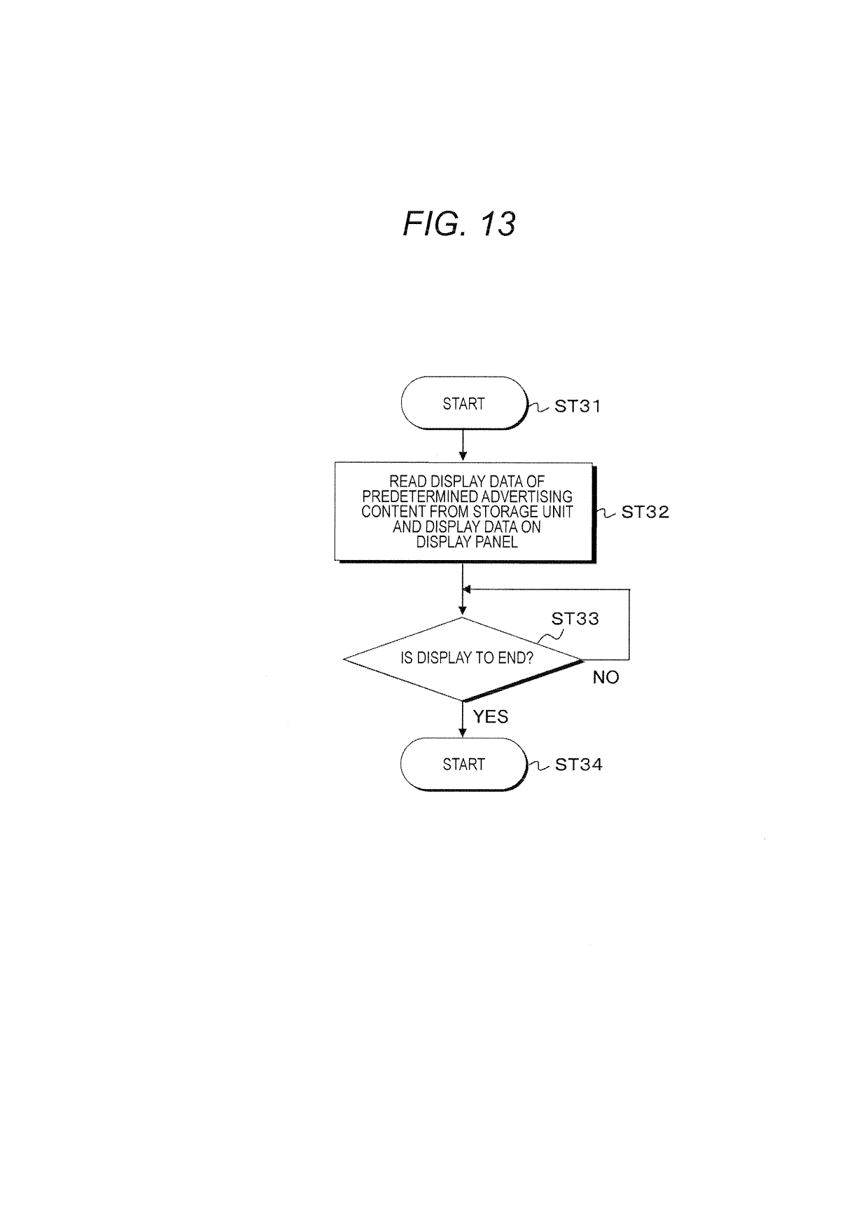

A flowchart of FIG. 13 illustrates a display process procedure of predetermined advertising content in the location terminal 200 (200-1 to 200-N). In step ST31, the location terminal 200 starts the process, and then causes the process to proceed to step ST32. In step ST32, the location terminal 200 reads the display data of the predetermined advertising content from the storage unit and displays the content through the display panel 210 at the display timing of the predetermined advertising content. In this case, the display panel 210 displays the viewer-captured images of the predetermined number of location terminals together with the predetermined advertising content.

After the process of step ST32, in step ST33, the location terminal 200 determines whether or not the display is to end. The location terminal 200 determines that the display is to end when it is determined that the display period of time of the predetermined advertising content gas ended or when the user performs a display off operation. When it is determined that the display is to end, in step ST34, the location terminal 200 ends the process.

As described above, in the signage system 10 illustrated in FIG. 1, the predetermined advertising content and the display data for displaying the viewer-captured images of the predetermined number of location terminals are transmitted from the center server 100 to the location terminals 200-1 to 200-N. Then, the display panels 210 of the location terminals 200-1 to 200-N display the predetermined advertising content and the viewer-captured images of the predetermined number of location terminals at the display timing of the predetermined advertising content.

Thus, even when a few people view the predetermined advertising content around the viewer, due to the viewers in the viewer-captured images of the predetermined number of location terminals, the viewer of the predetermined advertising content has sympathy, gets interested in, and is easily drawn to the predetermined advertising content. Thus, for example, the advertising effect of the predetermined advertising content is improved.

In the signage system 10 illustrated in FIG. 1, the center server 100 generates the ranking information in which the location terminal having many viewers is valued into a high ranking based on the viewer number information transmitted from the location terminals 200-1 to 200-N. Then, the center server 100 selects a predetermined number of location terminals having many viewers based on the ranking information, generates the display data including the viewer-captured image data and transmits the display data to the location terminals 200-1 to 200-N.

Thus, many viewers view the viewer-captured images of a predetermined number of location devices in which the predetermined advertising content is displayed on the display panels 210 of the location terminals 200-1 to 200-N. Thus, due to many viewers in the viewer-captured images of the predetermined number of location terminals, the viewer of the predetermined advertising content has sympathy and is easily drawn to the predetermined advertising content, and thus the advertising effect of the predetermined advertising content is further improved.

Further, in the signage system 10 illustrated in FIG. 1, the viewer-captured image data of the predetermined advertising content and the viewer number information are transmitted from the location terminals 200-1 to 200-N to the center server 100. Thus, the center server 100 need not perform the process of acquiring the viewer number information from the viewer-captured image data of the location terminals 200-1 to 200-N, and thus a processing load is reduced.

Further, in the signage system 10 illustrated in FIG. 1, the information request including the content specifying information may be transmitted from the center server 100 to the location terminals 200-1 to 200-N. Then, as a result, the center server 100 can receive the viewer-captured image data and the viewer number information of the predetermined advertising content specified by the content specifying information from the location terminals 200-1 to 200-N. Thus, the center server 100 can update the display data to be transmitted to the location terminals 200-1 to 200-N.

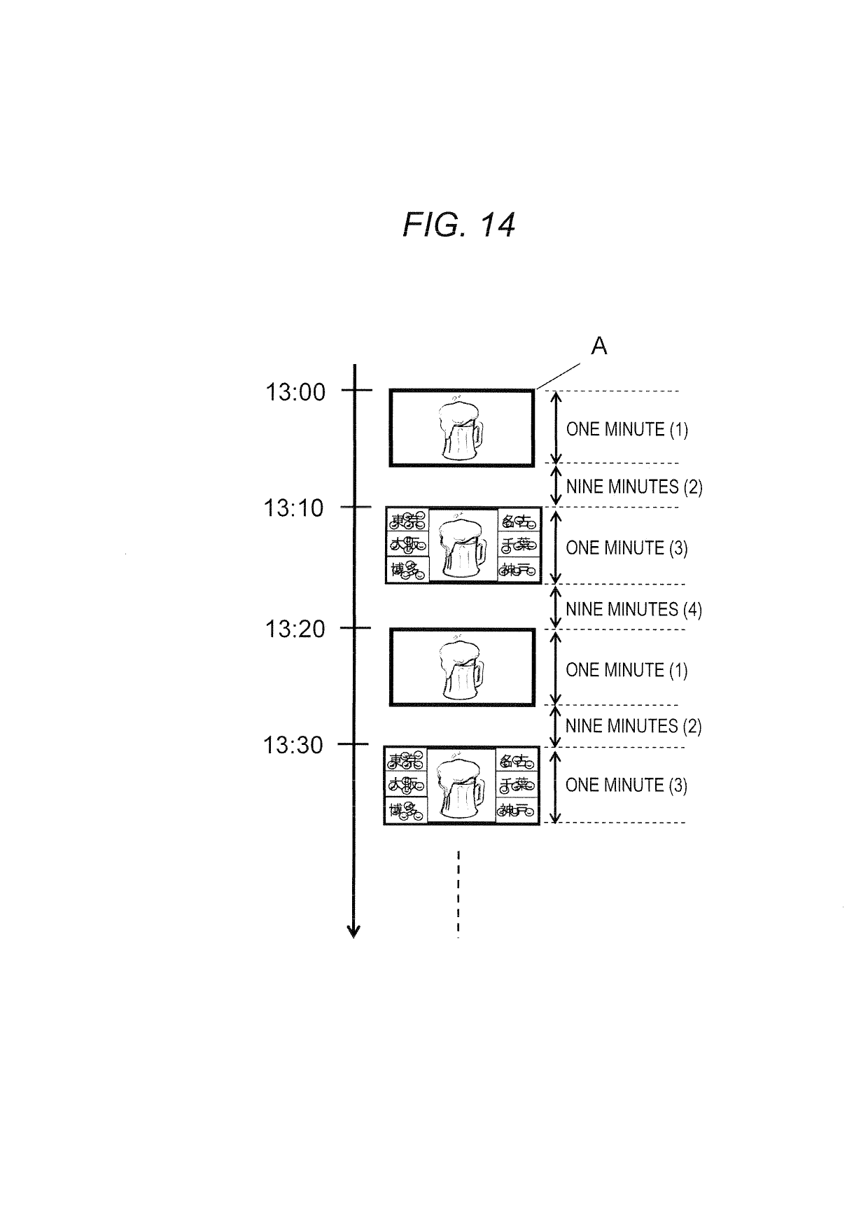

FIG. 14 illustrates an example of a method of displaying content A in the location terminal 200 of the signage system 10 described above. In this example, the content A is displayed during one minute at 10-minute intervals. In this case, (1) the content A is displayed during one minute, and the viewer is captured at the same time. After the display period of time elapses, the viewer-captured image data and the viewer number information obtained by the process are transmitted to the center server 100.

(2) Each content is displayed during nine minutes. During this period of time, the display data for displaying the viewer-captured images of the predetermined number of location terminals and the content A are received from the center server 100. (3) Thereafter, during one minute, the viewer-captured images of the predetermined number of location terminals are displayed together with the content A based on the received display data. (4) During nine minutes, each content is displayed. Thereafter, the process of (1) to (4) described above is continuously repeated.

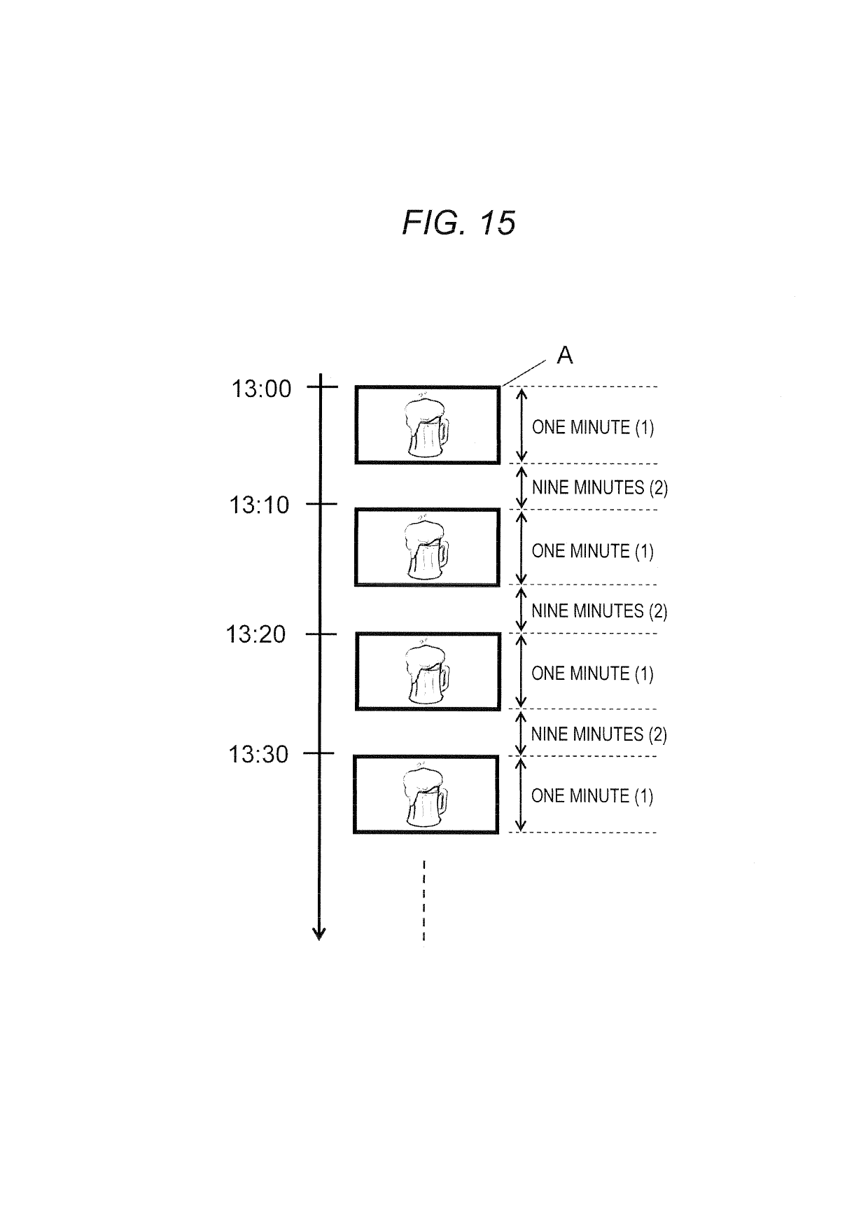

FIG. 15 illustrates an example of a method of displaying content A in a location terminal according to the related art. Even in this example, the content A is displayed during one minute at 10-minute intervals. In this case, (1) the content A is displayed during one minute. (2) Each content is displayed during nine minutes. Thereafter, the process of (1) and (2) is continuously repeated.

The location terminal 200 of the signage system 10 can perform the display method illustrated in FIG. 14. In this display method, the display can be changed each time compared to the display method of FIG. 15 by which the same display is repeated. Thus, the advertising effect by which the viewer is further interested in can be obtained.

### 2. Modified Examples

### First Modified Example

The above-described embodiment has been described in connection with the example in which the location terminals 200-1 to 200-N process the viewer-captured image data of the predetermined advertising content and acquire the viewer number information. However, the viewer number acquiring process may be performed by the center server 100 in order to reduce the processing load of the location terminals 200-1 to 200-N.

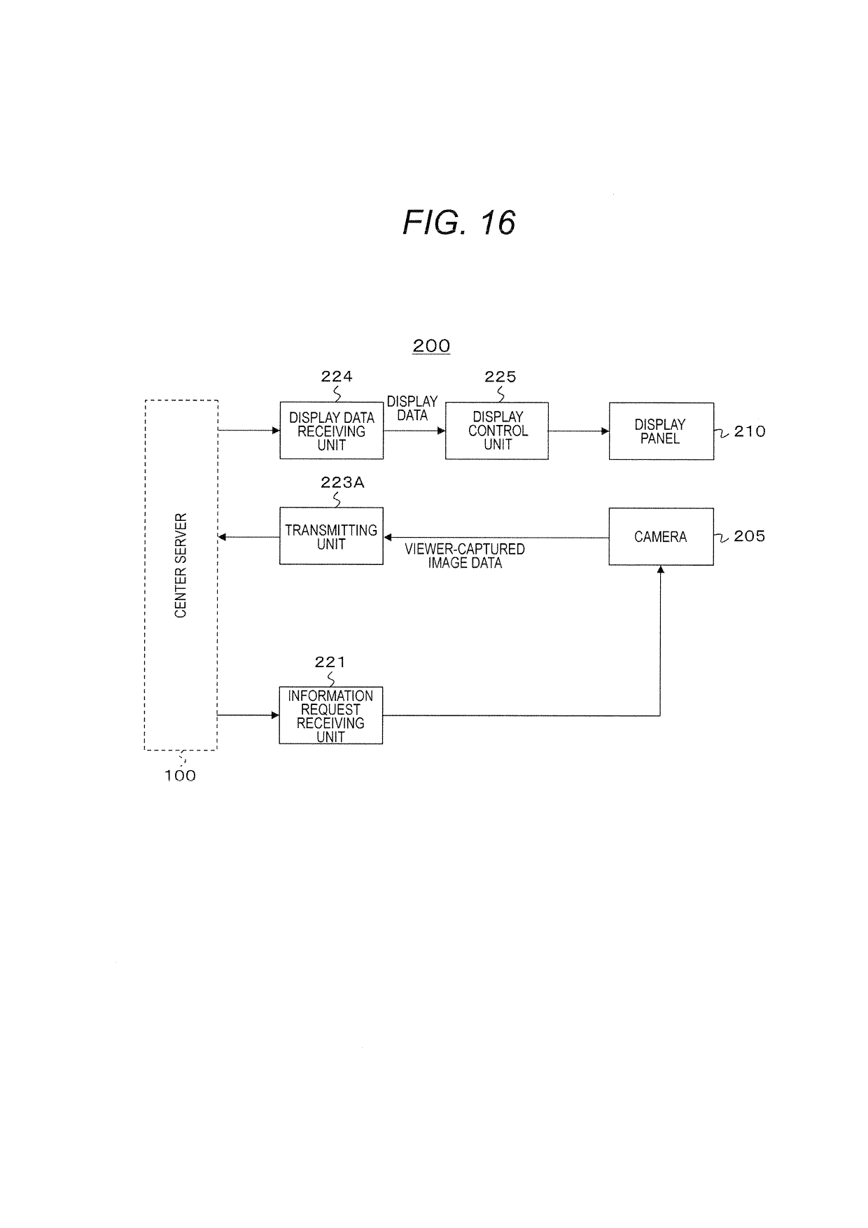

FIG. 16 is a functional block diagram illustrating main functions of the location terminal 200 in this case. In FIG. 16, the same components as in FIG. 6 are denoted by the same reference numerals. The functional block diagram of FIG. 16 does not include the image data processing unit 222 included in the functional block diagram of FIG. 6. Further, in the functional block diagram illustrated in FIG. 16, the transmitting unit 223A transmits just the viewer-captured image data of the predetermined advertising content obtained by the camera 205 to the center server 100.

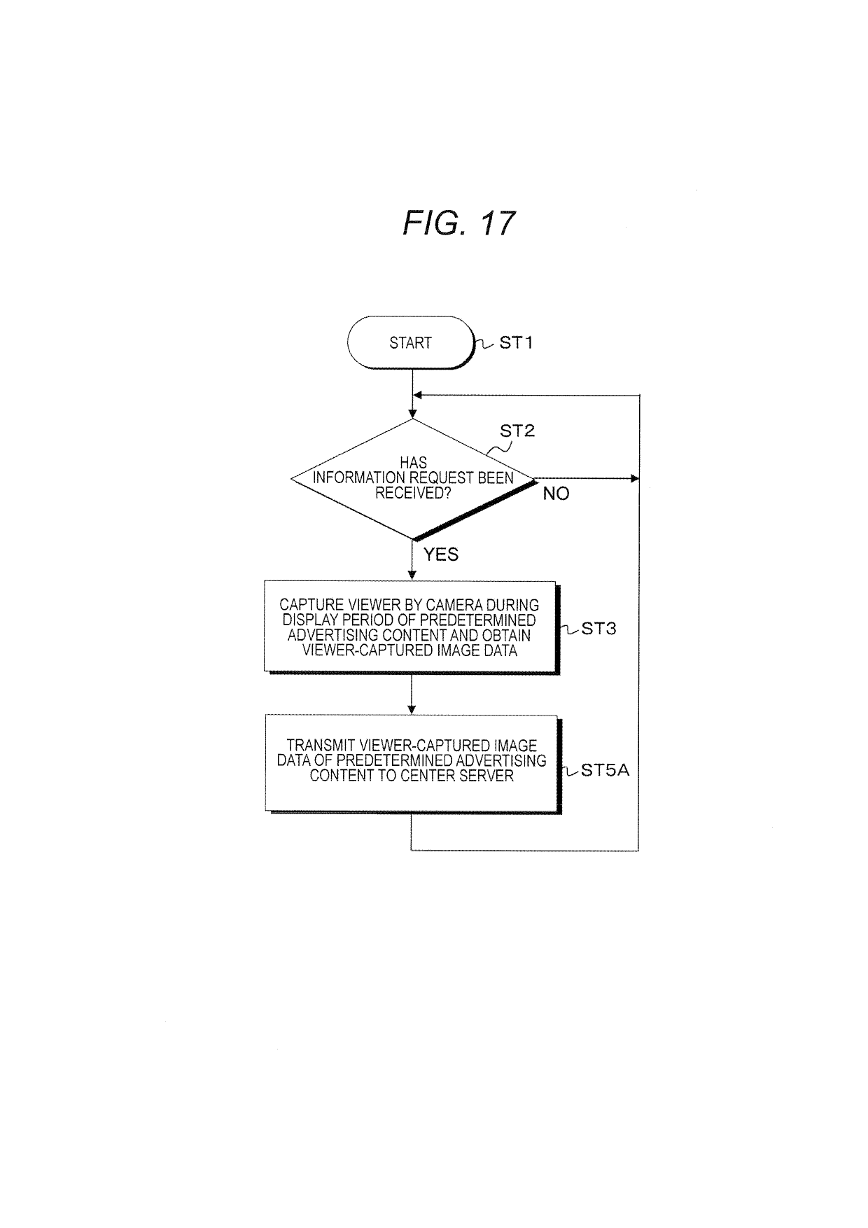

A flowchart of FIG. 17 illustrates a transmission process procedure of the viewer-captured image data in the location terminal 200 (200-1 to 200-N) in this case. In the flowchart of FIG. 17, the same steps as in the flowchart of FIG. 10 are denoted by the same reference numerals. The flowchart of FIG. 17 does not include processing step (step ST4) of processing the viewer-captured image data and acquiring the viewer number information included in the flowchart of FIG. 10. Further, in the flowchart of FIG. 17, in step ST5A corresponding to step ST5 of the flowchart of FIG. 10, the location terminal 200 transmits just the viewer-captured image data of the predetermined advertising content to the center server 100.

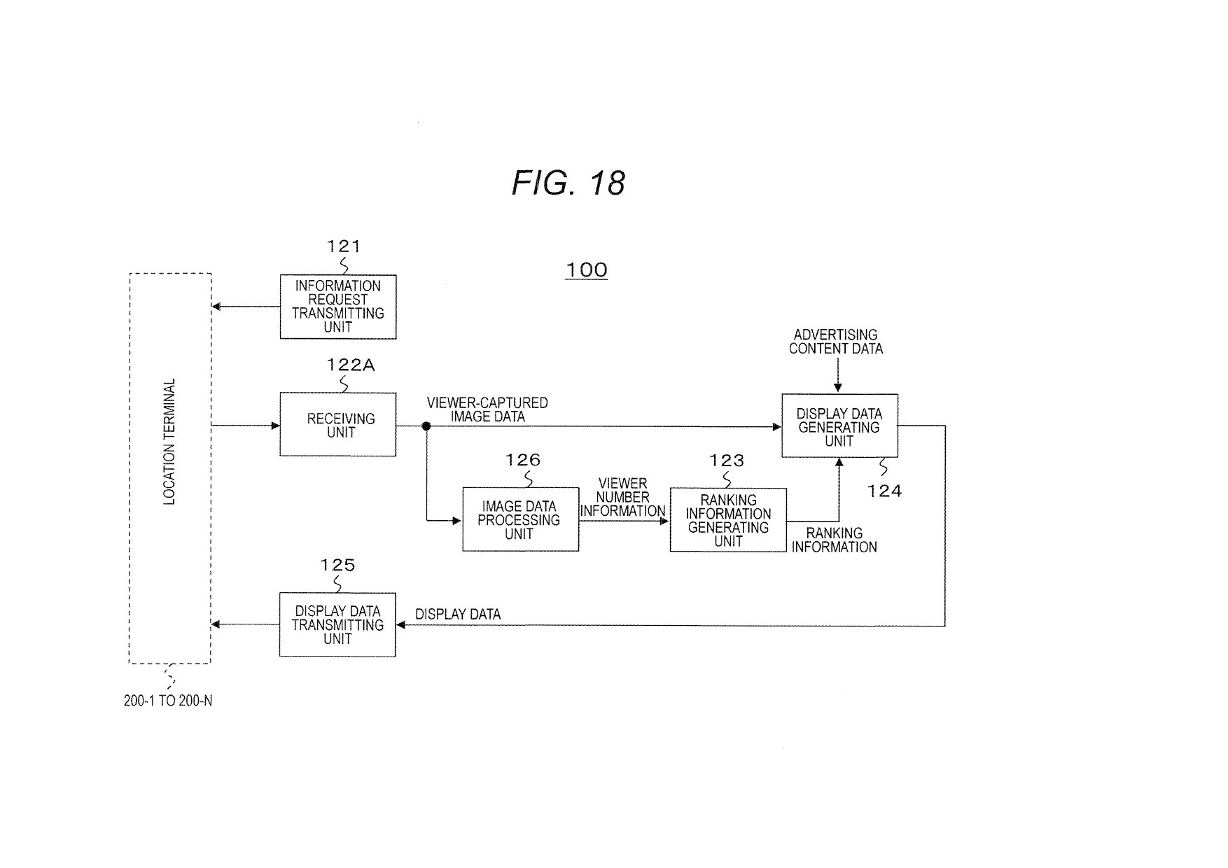

FIG. 18 is a functional block diagram illustrating main functions of the center server 100 in this case. In FIG. 18, the same components as in FIG. 8 are denoted by the same reference numerals. The functional block diagram of FIG. 18 includes an image data processing unit 126 which is not included in the functional block diagram of FIG. 8. The image data processing unit 126 processes the viewer-captured image data of the predetermined advertising content received by the receiving unit 122A, and acquires the viewer number information. Then, the ranking information generating unit 123 generates the ranking information of the location terminals 200-1 to 200-N based on the viewer number information of the location terminals 200-1 to 200-N acquired by the image data processing unit 126.

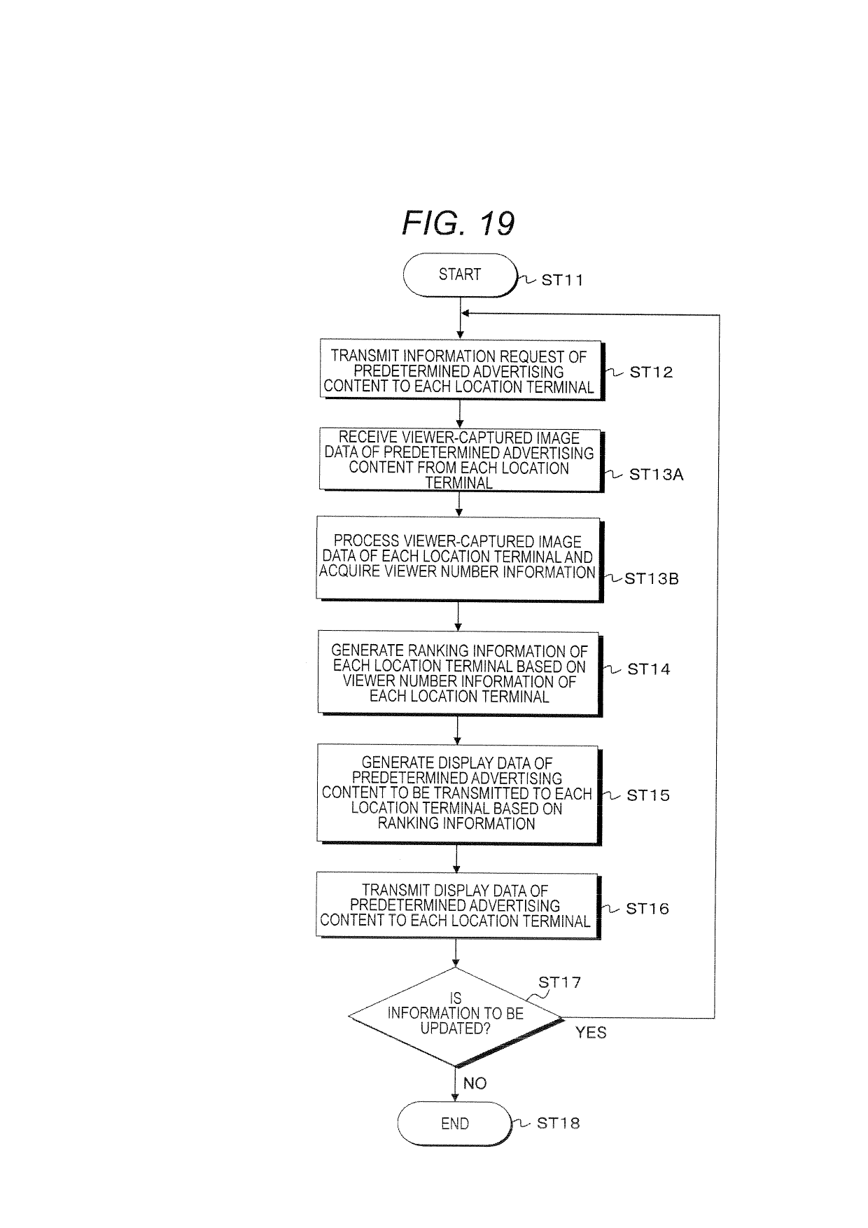

A flowchart of FIG. 19 illustrates a transmission process procedure of the display data in the center server 100 in this case. In the flowchart of FIG. 19, the same steps as in the flowchart of FIG. 11 are denoted by the same reference numerals. The flowchart of FIG. 19 includes steps ST13A and ST13B instead of step ST13 in the flowchart of FIG. 11. In step ST13A, the center server 100 receives the viewer-captured image data of the predetermined advertising content transmitted from the location terminals 200-1 to 200-N. In step ST13B, the center server 100 processes the viewer-captured image data of the location terminals 200-1 to 200-N received in step ST13A and acquires the viewer number information of the location terminals 200-1 to 200-N. Then, in step ST14, the center server 100 generates the ranking information based on the viewer number information acquired in step ST13B.

### Second Modified Example

The above-described example has been described in connection with the example in which the center server 100 generates the display data including the predetermined advertising content data and the viewer-captured image data of the predetermined number of location terminals, and transmits the display data to the location terminals 200-1 to 200-N. However, the display data may be generated by the location terminals 200-1 to 200-N. In this case, it is possible to cause live viewer-captured images captured by a predetermined number of location terminals to be displayed on the display panel 110 together with the predetermined advertising content.

In this case, the information request including the content specifying information is transmitted from the center server 100 to the location terminals 200-1 to 200-N. The location terminals 200-1 to 200-N receive the information request transmitted from the center server 100. The location terminals (terminal devices) 200-1 to 200-N capture the viewer of the predetermined advertising content specified by the content specifying information according to the information request. In this case, the predetermined advertising content is displayed on the display panel 210, and for example, during a period of time of 30 seconds or one minute, for example, the viewer of the predetermined advertising content is captured by the camera 105 installed on the upper end of the display panel 210.

Further, the location terminals 200-1 to 200-N process the viewer-captured image data captured and obtained by the camera 105 and acquires the viewer number information. The process of acquiring the viewer number information is performed using the facial image recognition technique disclosed in Japanese Patent Application Laid-Open No. 2008-112401 or the like as described above. The viewer number information obtained by the location terminals 200-1 to 200-N is transmitted to the center server 100.

The center server 100 receives the viewer number information of the predetermined advertising content transmitted from the location terminals 200-1 to 200-N. The center server 100 values the location terminal having many viewers among the location terminals 200-1 to 200-N into a high ranking based on the viewer number information, and generates the ranking information of the location terminals 200-1 to 200-N. The ranking information is transmitted to the location terminals 200-1 to 200-N.

The location terminals 200-1 to 200-N select a predetermined number of location terminals based on the ranking information of the location terminals 200-1 to 200-N transmitted from the center server 100. For example, the predetermined number of location terminals are selected in the descending order of the number of viewers. The location terminals 200-1 to 200-N can be set so that its own location terminal is not included in the predetermined number of location terminals.

The location terminals 200-1 to 200-N acquire the viewer-captured image data from the selected predetermined number of location terminals at the display timing of the predetermined advertising content. In this case, when its own location terminal is included in the predetermined number of location terminals, the camera 105 enters a viewer capturing state, and the live viewer-captured image data is obtained. Further, regarding another location terminal included in the predetermined number of location terminals, access to the corresponding location terminal is made, and live viewer-captured image data is received from the corresponding location terminal.

The location terminals 200-1 to 200-N generate the display data at the display timing of the predetermined advertising content. The display data includes the content data for displaying the predetermined advertising content on the first display region and the viewer-captured image data for displaying the live viewer-captured images of the predetermined number of location terminals described above on the predetermined number of second display regions.

The location terminals 200-1 to 200-N generate the display data, for example, using the display template (see FIG. 2). The display data is generated such that content data and image data are arranged on the display template. For example, the display template is configured such that a first display region is positioned on a screen center, and a predetermined number of second display regions are positioned around the first display region. The content data for displaying the predetermined content is delivered from the center server 100 to the location terminals 200-1 to 200-N in advance independently or through an arrangement on the display template.

The location terminals 200-1 to 200-N perform a display based on the display data generated as described above through the display panel 210 at the display timing of the predetermined advertising content. In this case, the display panel 210 displays the predetermined advertising content and the live viewer-captured images of the predetermined number of location terminals. For example, the predetermined number of location terminals are selected in the descending order of the number of viewers based on the ranking information of the location terminals 200-1 to 200-N as described above. Thus, relatively many viewers are included in the viewer-captured images of the predetermined number of location terminals displayed on the display panel 210.

[Functional Blocks of Location Terminal and Center Server]

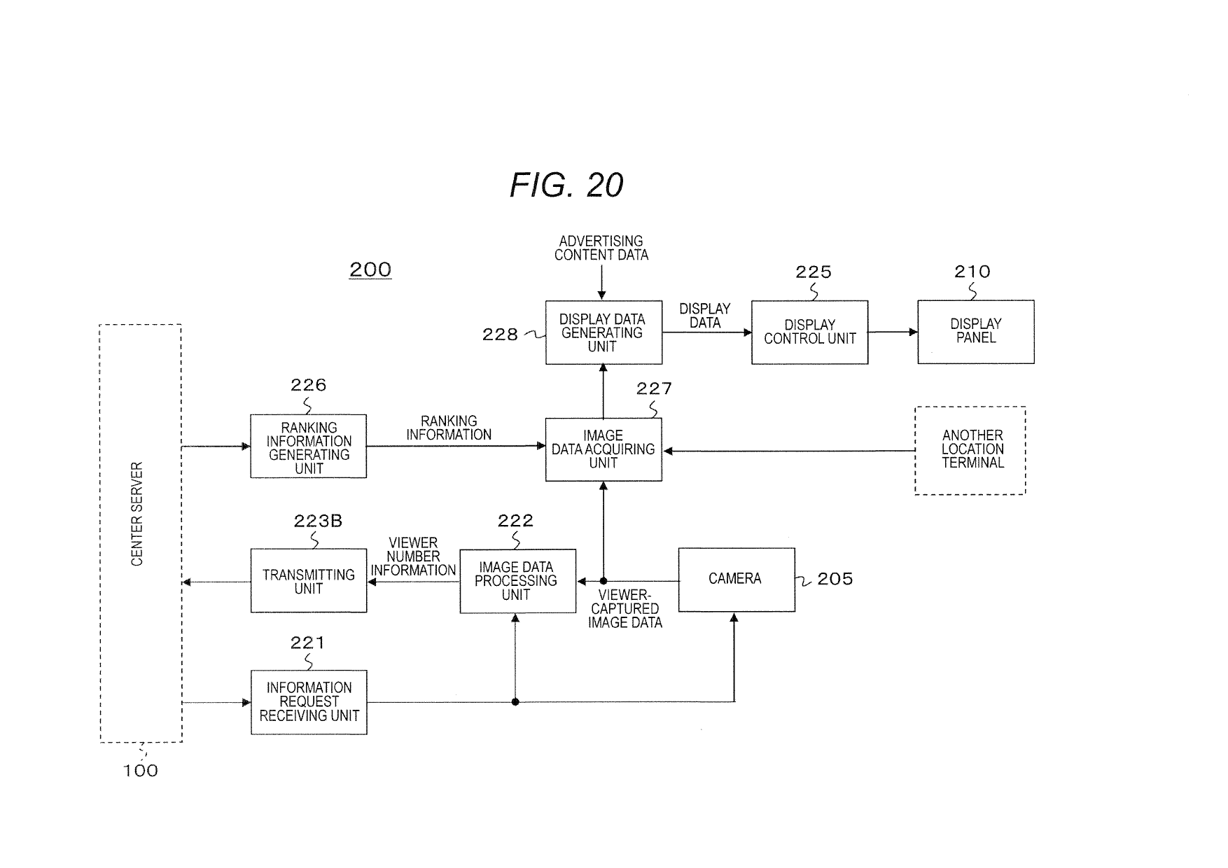

FIG. 20 is a functional block diagram illustrating main functions of the location terminal 200. In FIG. 20, the same components as in FIG. 6 are denoted by the same reference numerals. The location terminal 200 includes the following functional portions in addition to a camera 205 and a display panel 210. In other words, the location terminal 200 includes an information request receiving unit 221, an image data processing unit 222, a transmitting unit 223B, a ranking information receiving unit 226, an image data acquiring unit 227, a display data generating unit 228, and a display control unit 225. The information request receiving unit 221 receives the information request including the content specifying information transmitted from the center server 100.

The camera 205 captures the viewer during a period of time in which the predetermined advertising content specified by the content specifying information included in the information request received by the information request receiving unit 221 is displayed on the display panel 210, and obtains the viewer-captured image data. The image data processing unit 222 processes the viewer-captured image data of the predetermined advertising content obtained by the camera 205, and acquires the viewer number information. The transmitting unit 223B transmits the viewer number information of the predetermined advertising content acquired by the image data processing unit 222 to the center server 100.

The ranking information receiving unit 226 receives the ranking information of the location terminals 200-1 to 200-N transmitted from the center server 100. The image data acquiring unit 227 selects a predetermined number of location terminals from among the location terminals 200-1 to 200-N based on the ranking information. For example, the predetermined number of location terminals are selected in the descending order of the number of viewers. The image data acquiring unit 227 may make setting such that its own location terminal is not included in the predetermined number of location terminals.

The image data acquiring unit 227 acquires the viewer-captured image data from the selected predetermined number of location terminals at the display timing of the predetermined advertising content. In this case, when its own location terminal is included in the predetermined number of location terminals, the camera 105 enters the viewer capturing state, and the live viewer-captured image data is obtained. Further, regarding another location terminal included in the predetermined number of location terminals, access to the corresponding location terminal is made, and live viewer-captured image data is received from the corresponding location terminal.

The display data generating unit 228 generates the display data using the viewer-captured image data of the predetermined number of location terminals acquired by the image data acquiring unit 227 at the display timing of the predetermined advertising content. The display data includes the content data for displaying the predetermined advertising content on the first display region and the live viewer-captured image data of the predetermined number of location terminals described above on the predetermined number of second display regions.

The display control unit 225 causes the predetermined advertising content and the live viewer-captured image of the predetermined number of location terminals to be displayed on the display panel 210 at the display timing of the predetermined advertising content based on the display data generated by the display data generating unit 228. The information request receiving unit 221, the transmitting unit 223B, the ranking information receiving unit 226, and the image data acquiring unit 227 (a portion related to another location terminal) are implemented by the communication interface 206. The image data processing unit 222, the display data generating unit 228, the display control unit 225, and the image data acquiring unit 227 (a portion related to its own location terminal) are implemented by the CPU 201.

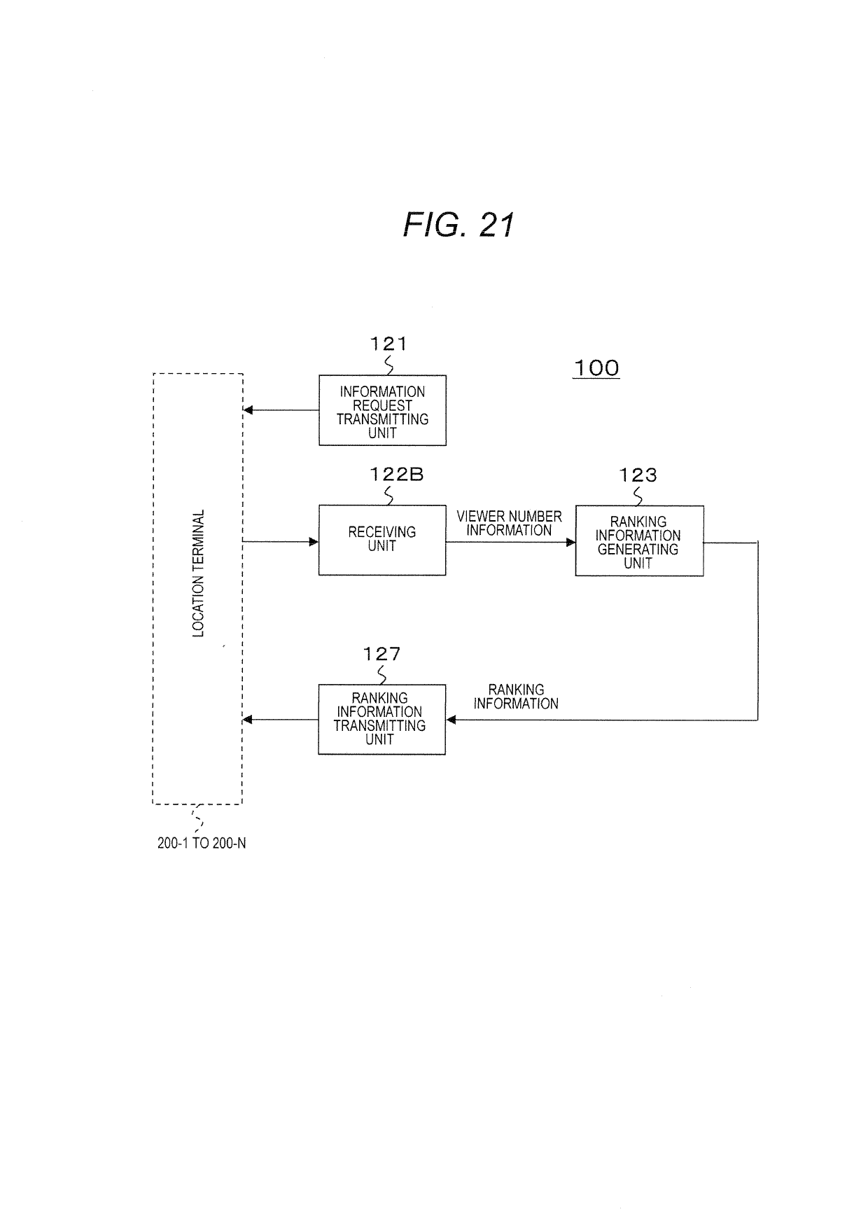

FIG. 21 is a functional block diagram illustrating main functions of the center server 100. In FIG. 21, the same components as in FIG. 8 are denoted by the same reference numerals. The center server 100 includes an information request transmitting unit 121, a receiving unit 122B, a ranking information generating unit 123, and a ranking information transmitting unit 127. The information request transmitting unit 121, the receiving unit 122B, and the ranking information transmitting unit 127 are implemented by the communication interface 105. The ranking information generating unit 123 is implemented by the CPU 101. The information request transmitting unit 121 transmits the information request including the content specifying information to the location terminals 200-1 to 200-N.

The receiving unit 122B receives the viewer number information of the predetermined advertising content transmitted from the location terminals 200-1 to 200-N. The ranking information generating unit 123 generates the ranking information of the location terminals 200-1 to 200-N based on the viewer number information of the location terminals 200-1 to 200-N received by the receiving unit 122B. In this case, the ranking information generating unit 123 values the location terminal having many viewers into a high ranking. The ranking information transmitting unit 127 transmits the ranking information generated by the ranking information generating unit 123 to the location terminals 200-1 to 200-N.

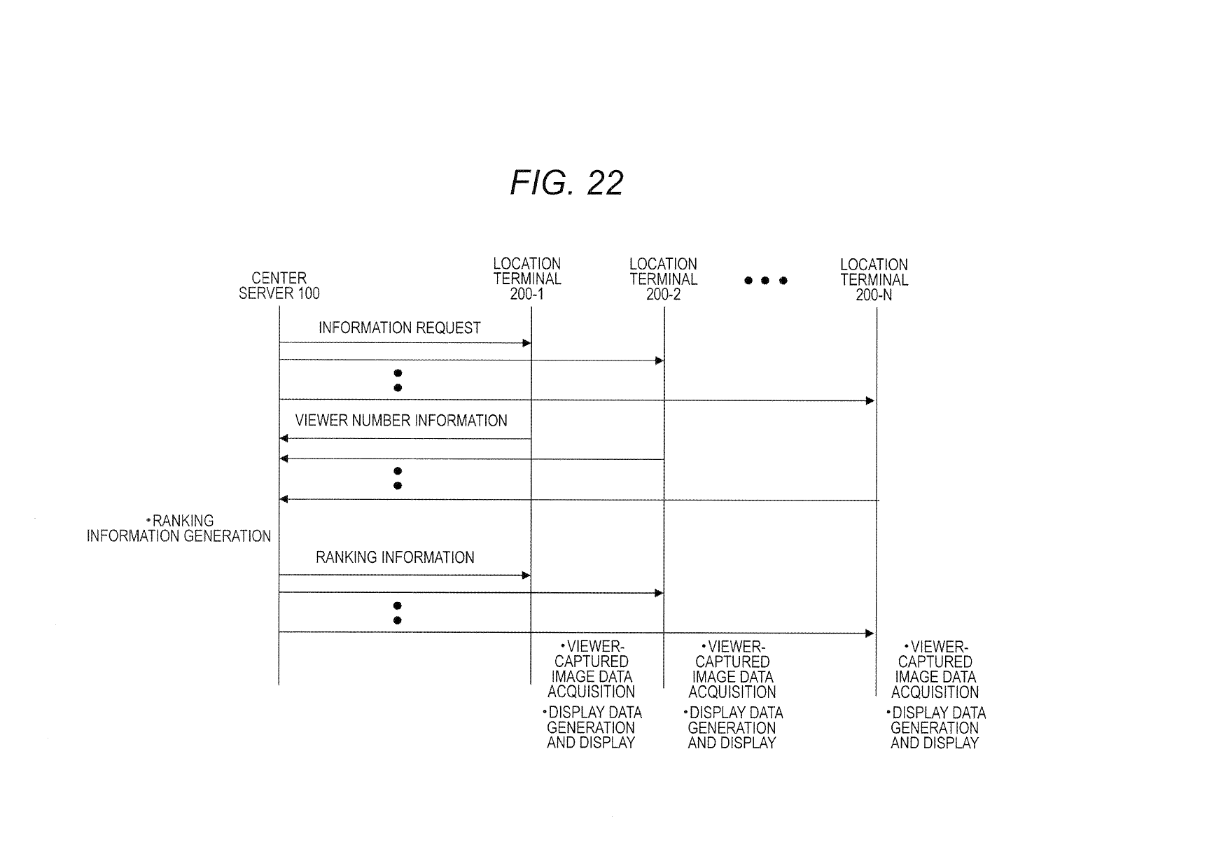

A sequence diagram of FIG. 22 schematically illustrates exchange of data or information between the center server 100 and the location terminals 200-1 to 200-N. First, the information request including the content specifying information is transmitted from the center server 100 to the location terminals 200-1 to 200-N. On the other hand, the viewer number information of the predetermined advertising content specified by the content specifying information is transmitted from the location terminals 200-1 to 200-N to the center server 100.

Thereafter, the center server 100 values a location terminal having many viewers into a high ranking based on the viewer number information of the location terminals 200-1 to 200-N, and generates the ranking information of the location terminals 200-1 to 200-N. Then, the ranking information generated as described above is transmitted from the center server 100 to the location terminals 200-1 to 200-N.

For example, the location terminals 200-1 to 200-N select a predetermined number of location terminals having many viewers based on the ranking information. Then, at the display timing of the predetermined advertising content, the viewer-captured image data of the predetermined number of location terminals is acquired, and the display data is generated. The display data includes the content data for displaying the predetermined advertising content on the first display region and the image data for displaying the live viewer-captured images of the predetermined number of location terminals on the predetermined number of second display regions.

The location terminals 200-1 to 200-N display the predetermined advertising content and the live viewer-captured images of the predetermined number of location terminals through the display panel 210 based on the display data at the display timing of the predetermined advertising content (see FIG. 4).

[Display Process Procedure of Location Terminal and Center Server]

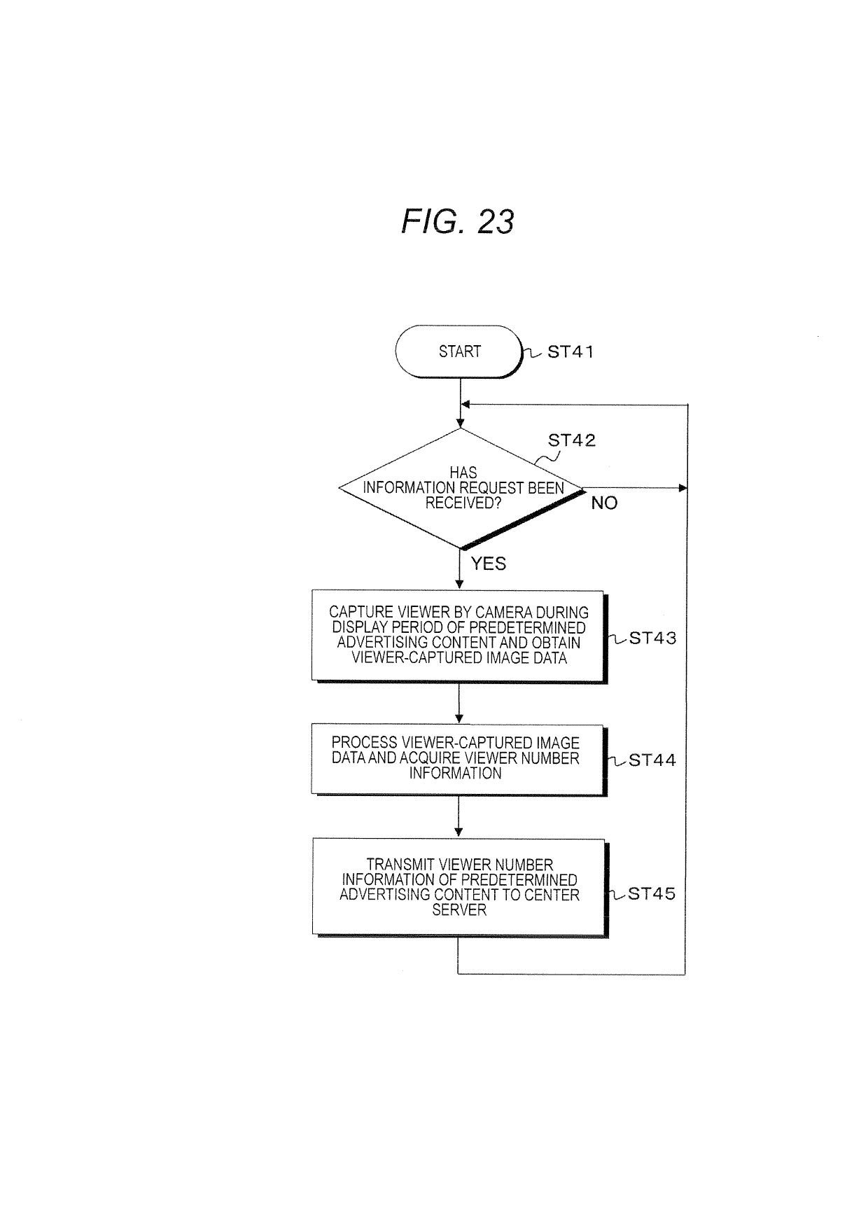

A flowchart of FIG. 23 illustrates a transmission process procedure of the viewer number information in the location terminal 200 (200-1 to 200-N). In step ST41, the location terminal 200 starts the process, and then causes the process to proceed to step ST42.

In step ST42, the location terminal 200 determines whether or not the information request including the content specifying information has been received from the center server 100. When it is determined that the information request has been received, the location terminal 200 causes the process to proceed to step ST43. In step ST43, the location terminal 200 captures the viewer through the camera 205 in a period of time in which the predetermined advertising content specified by the content specifying information included in the information request is displayed on the display panel 210, and acquires the viewer-captured image data.

Next, in step ST44, the location terminal 200 processes the viewer-captured image data obtained in step ST43, and acquires the viewer number information. Then, in step ST45, the location terminal 200 transmits the viewer number information of the predetermined advertising content acquired in step ST44 to the center server 100. After the process of step ST45 ends, the location terminal 200 causes the process to return to step ST42.

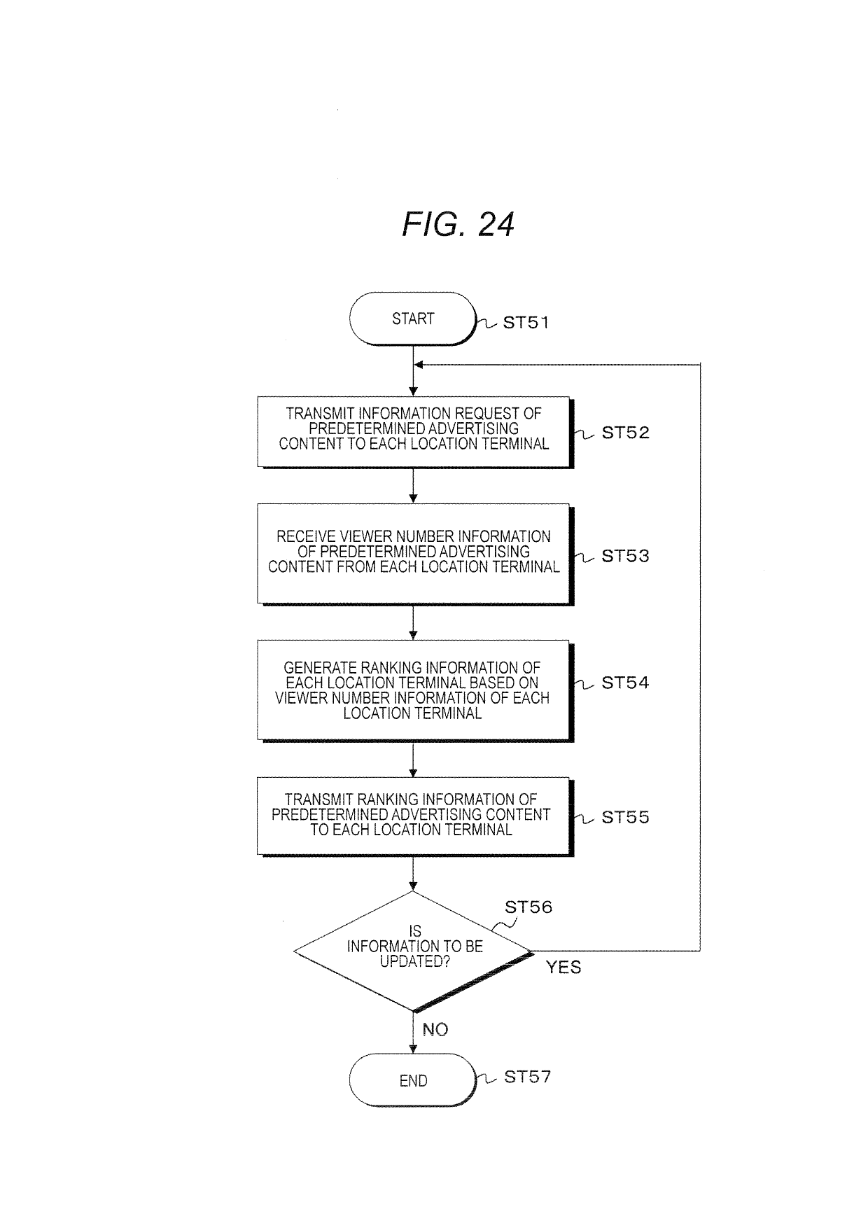

A flowchart of FIG. 24 illustrates a transmission process procedure of the ranking information in the center server 100. In step ST51, the center server 100 starts the process, and then causes the process to proceed to step ST52. In step ST52, the center server 100 transmits an information request including content information of predetermined advertising content to the location terminals 200-1 to 200-N.

Next, in step ST53, the center server 100 receives the viewer number information of the predetermined advertising content transmitted from the location terminals 200-1 to 200-N. Then, in step ST54, the center server 100 generates the ranking information of the location terminals 200-1 to 200-N based on the viewer number information of the location terminals 200-1 to 200-N received in step ST53. In this case, a location terminal having many viewers is valued into a high ranking.

Next, in step ST55, the center server 100 transmits the ranking information generated in step ST54 to the location terminals 200-1 to 200-N. Then, after the process of step ST55, in step ST56, the center server 100 determines whether or not information is to be updated. The user sets whether or not information is to be updated in advance. When it is determined that information is to be updated, the center server 100 causes the process to return to step ST52. However, when it is determined that information is not to be updated, in step ST57, the center server 100 ends the process.

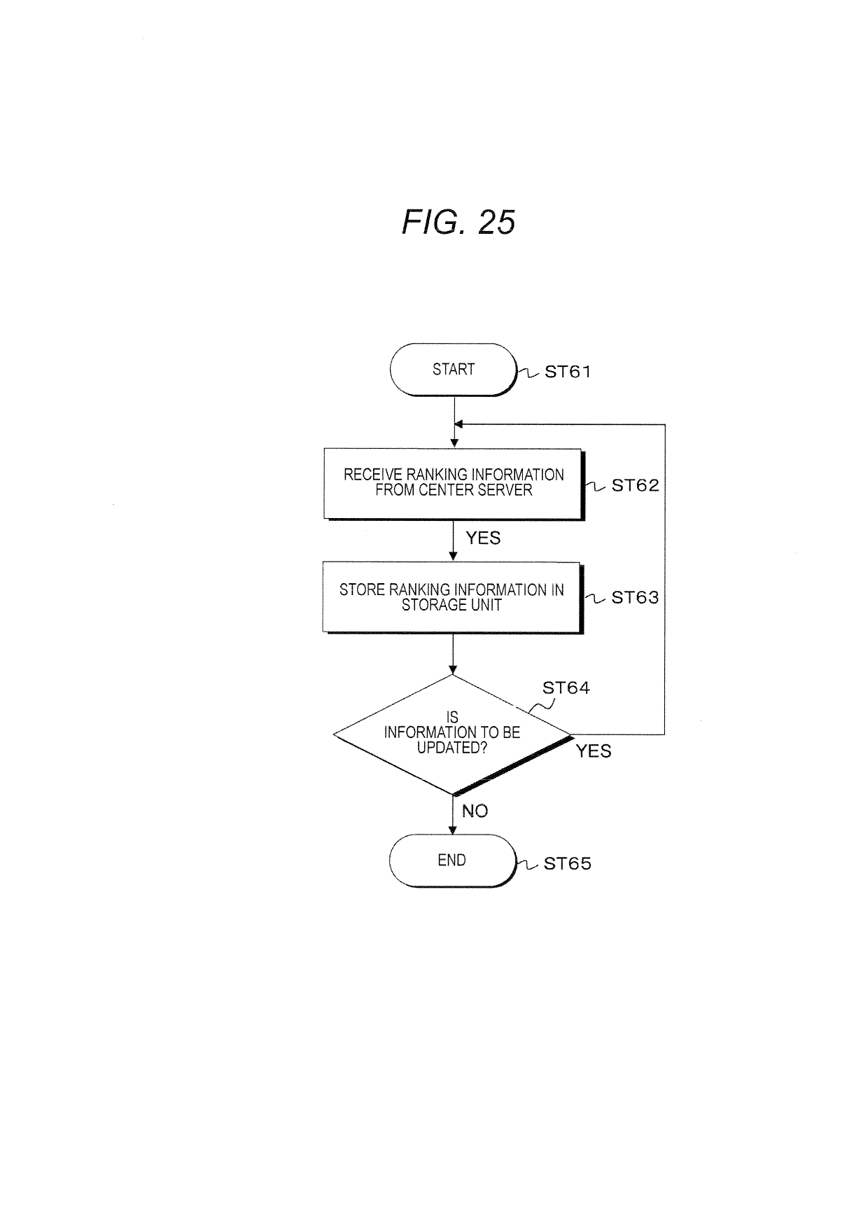

A flowchart of FIG. 25 illustrates a reception process procedure of the ranking information in the location terminal 200 (200-1 to 200-N). In step ST61, the location terminal 200 starts the process, and then causes the process to proceed to step ST62. In step ST62, the location terminal 200 receives the ranking information from the center server 100.

Next, in step ST63, the location terminal 200 stores the ranking information received in step ST62 in a storage unit such as a HDD. Then, after the process of step ST63, in step ST64, the location terminal 200 determines whether or not information is to be updated. The user sets whether or not information is to be updated in advance. When it is determined that information is to be updated, the location terminal 200 causes the process to return to step ST62. However, when it is determined that information is not to be updated, in step ST65, the location terminal 200 ends the process.

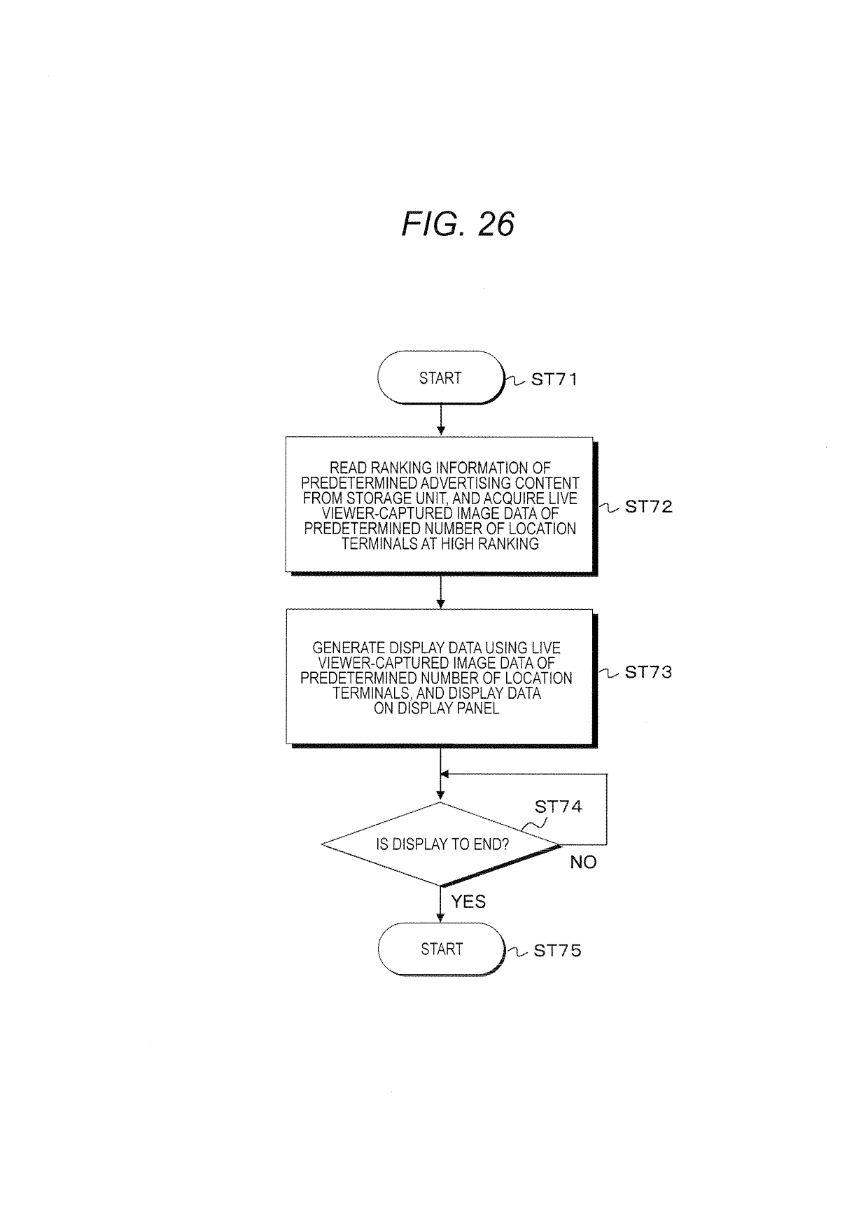

A flowchart of FIG. 26 illustrates a display process procedure of the predetermined advertising content in the location terminal 200 (200-1 to 200-N). In step ST71, the location terminal 200 starts the process, and then causes the process to proceed to step ST72. In step ST72, at the display timing of the predetermined advertising content, the location terminal 200 reads the ranking information of the predetermined advertising content from the storage unit, and acquires the live viewer-captured image data of the predetermined number of location terminals valued in a high ranking.

Next, in step ST73, the location terminal 200 generates the display data using the live viewer-captured image data of the predetermined number of location terminals acquired in step ST72, and displays content thereof through the display panel 210. In this case, the display panel 210 displays the predetermined advertising content and the live viewer-captured images of the predetermined number of location terminals.

After the process of step ST73, in step ST74, the location terminal 200 determines whether or not a display is to end. The location terminal 200 determines that the display is to end when it is determined that the display period of time of the predetermined advertising content has ended or when the user performs a display off operation. When it is determined that the display is to end, in step ST75, the location terminal 200 ends the process.

### Third Modified Example

The second modified example has been described in connection with the example in which the location terminals 200-1 to 200-N process the viewer-captured image data of the predetermined advertising content and acquire the viewer number information. However, the viewer number acquiring process may be performed by the center server 100 to reduce the processing load of the location terminals 200-1 to 200-N.

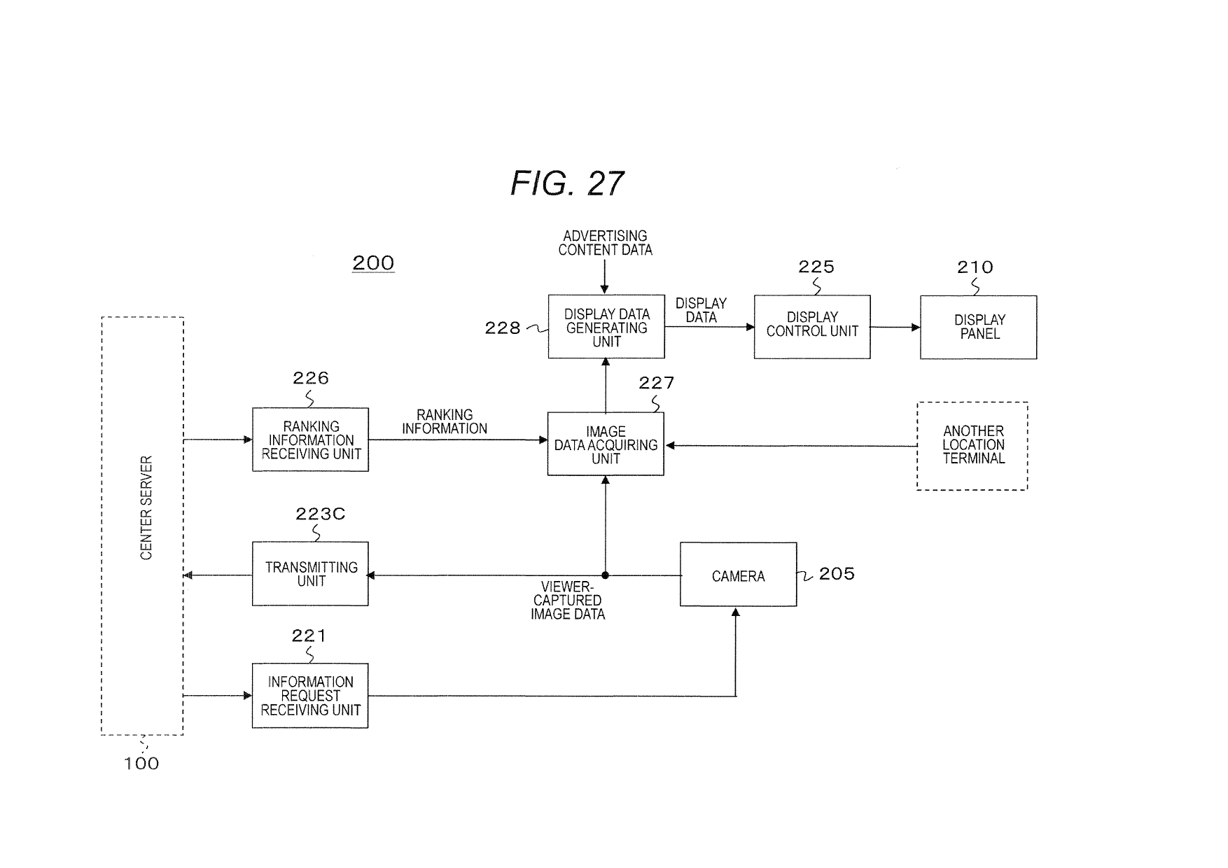

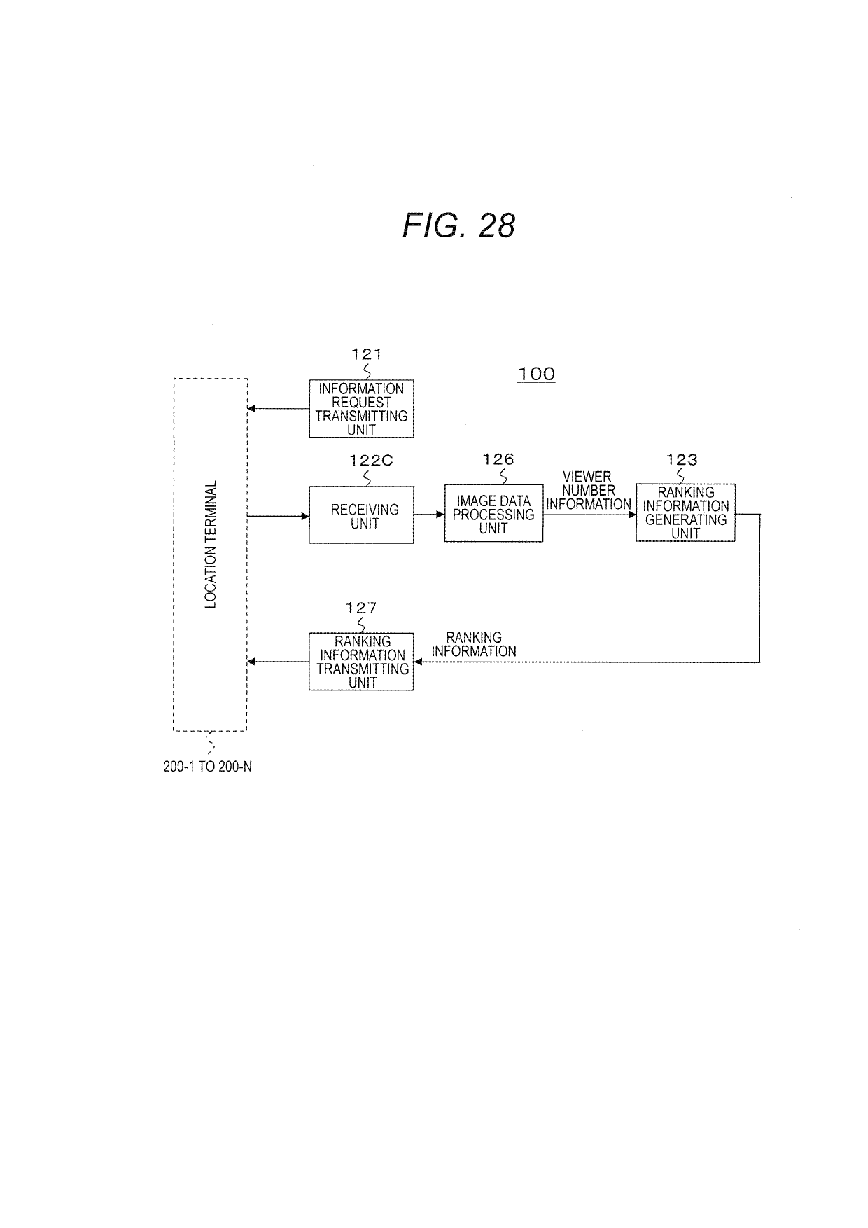

FIG. 27 is a functional block diagram illustrating main functions of the location terminal 200 in this case. In FIG. 27, the same components as in FIG. 20 are denoted by the same reference numerals. The functional block diagram of FIG. 27 does not include the image data processing unit 222 which is included in the functional block diagram of FIG. 20. In the functional block diagram of FIG. 27, a transmitting unit 223C transmits the viewer-captured image data of the predetermined advertising content obtained by the camera 205 to the center server 100. The flowchart of FIG. 17 illustrates the transmission process procedure of the viewer-captured image data in the location terminal 200 (200-1 to 200-N) in this case.

FIG. 28 is a functional block diagram illustrating of main functions of the center server 100 in this case. In FIG. 28, the same components as in FIG. 21 are denoted by the same reference numerals. The functional block diagram of FIG. 28 includes the image data processing unit 126 which is not included in the functional block diagram of FIG. 21. The image data processing unit 126 processes the viewer-captured image data of the location terminals 200-1 to 200-N of the predetermined advertising content received by the receiving unit 122C, and acquires the viewer number information. Further, the ranking information generating unit 123 generates the ranking information of the location terminals 200-1 to 200-N based on the viewer number information of the location terminals 200-1 to 200-N acquired by the image data processing unit 126.

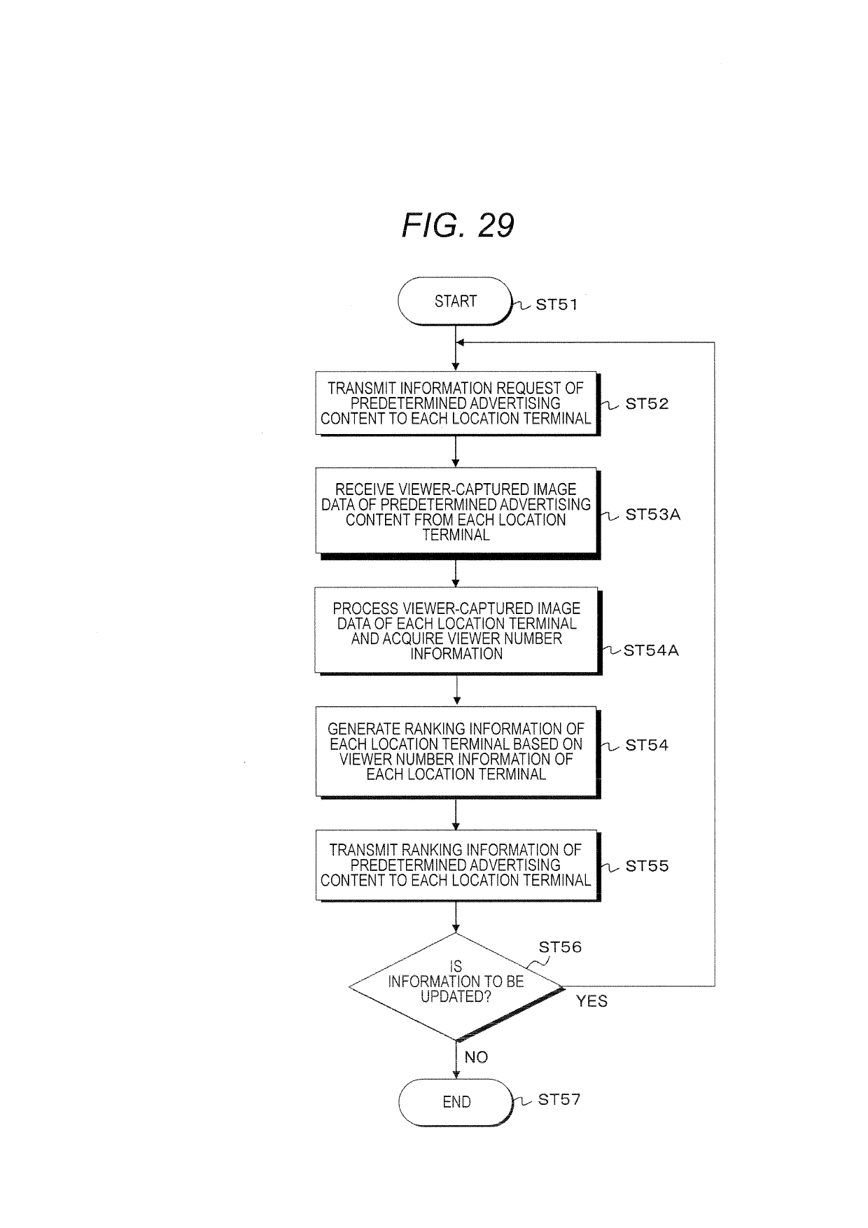

A flowchart of FIG. 29 illustrates a transmission process procedure of the display data in the center server 100 in this case. In the flowchart of FIG. 29, the same steps as in the flowchart of FIG. 24 are denoted by the same reference numerals. The flowchart of FIG. 29 includes steps ST53A and ST53B instead of step ST53 of the flowchart of FIG. 24.

In step ST53A, the center server 100 receives the viewer-captured image data of the predetermined advertising content transmitted from the location terminals 200-1 to 200-N. In step ST53B, the center server 100 processes the viewer-captured image data of the location terminals 200-1 to 200-N received in step ST53A, and acquires the viewer number information of the location terminals 200-1 to 200-N. Then, in step ST54, the center server 100 generates the ranking information based on the viewer number information acquired in step ST53B.

### Other Modified Example

The above description has been made in connection with the example in which the signage system 10 is illustrated, and the advertising content is delivered from the center server 100 to the location terminals 200-1 to 200-N. However, even when in a similar network system, any other content such as program content is transmitted from a center server to a plurality of location terminal, and the content is displayed on a display panel of each location terminal, the invention is similarly applied.

Further the above description has been made in connection with the example in which all of the location terminals 200-1 to 200-N transmit the viewer-captured image data and/or the viewer number information to the center server 100. In this case, the location terminals 200-1 to 200-N serve as candidates of a predetermined number of predetermined location terminals which are displayed together with the content. However, among the location terminals connected to the center server 100, there may be a location terminal having no function of transmitting the viewer-captured image data and/or the viewer number information. In this case, the location terminal does not serve as one of candidates of the predetermined number of predetermined location terminals which are displayed together with the content.

### INDUSTRIAL APPLICABILITY

For example, the invention may be applied to a signage system in a store such as a supermarket.

### REFERENCE SIGNS LIST

10 Signage system
100 Center server
101 CPU
105 Communication interface
106 IO interface
108 User operating unit
109 Display unit
121 Information request transmitting unit
122, 122A to 122C Receiving unit
123 Ranking information generating unit
124 Display data generating unit
125 Display data transmitting unit
126 Image data processing unit
127 Ranking information transmitting unit
200, 200-1 to 200-N Location terminal
201 CPU
205 Camera
206 Communication interface
207 IO interface
209 User operating unit
210 Display panel
221 Information request receiving unit
222 Image data processing unit
223, 223A to 223C Transmitting unit
224 Display data receiving unit
225 Display control unit
226 Ranking information receiving unit
227 Image data acquiring unit
228 Display data generating unit
300 Network

1. A terminal device, comprising:
a display data receiving unit that receives display data from a server device, the display data including content data for displaying predetermined content on a first display region and captured-image data for displaying viewer-captured images of the predetermined content of a predetermined number of terminal devices on a predetermined number of second display regions; and
a display control unit that causes the predetermined content and the viewer-captured images of the predetermined number of terminal devices to be displayed on a display panel based on the display data received by the display data receiving unit.

2. The terminal device according to claim 1, further comprising:
a camera that captures a viewer of the predetermined content during a period of time in which the predetermined content is displayed on the display panel; and
a transmitting unit that transmits at least viewer-captured image data obtained by the camera to the server device.

3. The terminal device according to claim 2, further comprising
an image data processing unit that processes the viewer-captured image data captured and obtained by the camera, and acquires viewer number information,
wherein the transmitting unit transmits the viewer-captured image data captured and obtained by the camera and the viewer number information acquired by the image data processing unit to the server device.

4. The terminal device according to claim 1,
wherein the predetermined content displayed on the display panel is advertising content.

5. The terminal device according to claim 2, further comprising
an information request receiving unit that receives an information request including content specifying information from the server device,
wherein when information request receiving unit receives the information request,
the camera captures a viewer of the predetermined content during a period of time in which the predetermined content specified by the content specifying information included in the information request is displayed on the display panel, and
the transmitting unit transmits the viewer-captured image data obtained by the camera to the server device.

6. The terminal device according to claim 1,
wherein the predetermined number of terminal devices are terminal devices which are selected from among a plurality of terminal devices based on the viewer number information of the predetermined content of the plurality of terminal devices in the server device.

7. A content display method of a terminal device, comprising the steps of:
receiving display data from a server device, the display data including content data for displaying predetermined content on a first display region and captured-image data for displaying viewer-captured images of the predetermined content of a predetermined number of terminal devices on a predetermined number of second display regions; and
causing the predetermined content and the viewer-captured images of the predetermined number of terminal devices to be displayed on a display panel based on the display data received in the receiving of the display data.

8. A server device, comprising:
a receiving unit that receives viewer-captured image data captured and obtained by a camera during a display period of time of predetermined content from a plurality of terminal devices;
a viewer number information acquiring unit that acquires viewer number information of the predetermined content of the plurality of terminal devices;
a ranking information generating unit that values a terminal device having many viewers into a high ranking based on the viewer number information of the plurality of terminal devices acquired by the viewer number information acquiring unit, and generates ranking information of the plurality of terminal devices;
a display data generating unit that generates display data including content data for displaying the predetermined content on a first display region and viewer-captured image data for displaying viewer-captured images of a predetermined number of terminal devices selected from among the plurality of terminal devices based on the ranking information generated by the ranking information generating unit on a predetermined number of second display regions, the viewer-captured image data being received by the receiving unit; and
a display data transmitting unit that transmits the display data generated by the display data generating unit to the terminal device.

9. The server device according to claim 8,
wherein the viewer number information acquiring unit receives the viewer number information from the plurality of terminal devices, and acquires the viewer number information of the predetermined content of the plurality of terminal devices.

10. The server device according to claim 8,
wherein the viewer number information acquiring unit processes the viewer-captured image data of the plurality of terminal devices received by the receiving unit, and acquires the viewer number information of the predetermined content of the plurality of terminal devices.

11. The server device according to claim 8, further comprising
an information request transmitting unit that transmits an information request including content specifying information to the plurality of terminal devices,
wherein the receiving unit receives the viewer-captured image data of the predetermined content transmitted from the plurality of terminal devices according to transmission of the information request by the information request transmitting unit, and
the viewer number information acquiring unit acquires the viewer number information of the predetermined content of the plurality of terminal devices according to transmission of the information request by the information request transmitting unit.

12. A display data transmission method of a server device, comprising the steps of:
receiving viewer-captured image data captured and obtained by a camera at a display period of time of predetermined content from a plurality of terminal devices;
acquiring viewer number information of the predetermined content of the plurality of terminal devices;
valuing a terminal device having many viewers into a high ranking based on the viewer number information of the plurality of terminal devices acquired by the acquiring of the viewer number information, and generating ranking information of the plurality of terminal devices;
generating display data including content data for displaying the predetermined content on a first display region and viewer-captured image data for displaying viewer-captured images of a predetermined number of terminal devices selected from among the plurality of terminal devices based on the ranking information generated by the valuing of the terminal device on a predetermined number of second display regions, the viewer-captured image data being received by the receiving of the receiving viewer-captured image data; and
transmitting the display data generated by the generating of the display data to the terminal device.

13. A terminal device, comprising:
a ranking information receiving unit that receives ranking information of a plurality of terminal devices obtained by valuing a terminal device having many viewers into a high ranking based on viewer number information of predetermined content of the plurality of terminal devices from a server device;
an image data acquiring unit that acquires viewer-captured image data of a predetermined number of terminal devices selected based on the ranking information of the plurality of terminal devices received by the ranking information receiving unit;
a display data generating unit that generates display data including content data for displaying the predetermined content on a first display region and viewer-captured image data for displaying viewer-captured images of a predetermined number of terminal devices on a predetermined number of second display regions, respectively, the viewer-captured image data being acquired by the image data acquiring unit; and
a display control unit that causes the predetermined content and the viewer-captured image of the predetermined number of imaging devices to be displayed on a display panel based on the display data generated by the display data generating unit.

14. The terminal device according to claim 13, further comprising:
a camera that captures a viewer of the predetermined content during a period of time in which the predetermined content is displayed on the display panel; and
a transmitting unit that transmits viewer-captured image data captured and obtained by the camera to the server device.

15. The terminal device according to claim 13, further comprising:
a camera that captures a viewer of the predetermined content during a period of time in which the predetermined content is displayed on the display panel;
an image data processing unit that processes viewer-captured image data captured and obtained by the camera and acquires viewer number information; and
a transmitting unit that transmits the viewer number information obtained by the image data processing unit to the server device.

16. A content display method of a terminal device, comprising the steps of:
receiving ranking information of a plurality of terminal devices obtained by valuing a terminal device having many viewers into a high ranking based on viewer number information of predetermined content of the plurality of terminal devices from a server device;
acquiring viewer-captured image data of a predetermined number of terminal devices selected based on the ranking information of the plurality of terminal devices received by the receiving of the ranking information;
generating display data including content data for displaying the predetermined content on a first display region and viewer-captured image data for displaying viewer-captured images of a predetermined number of terminal devices on a predetermined number of second display regions, respectively, the viewer-captured image data being acquired by the acquiring of the viewer-captured image data; and
causing the predetermined content and the viewer-captured image of the predetermined number of imaging devices to be displayed on a display panel based on the display data generated by the generating of the display data.

17. A server device, comprising:
a viewer number information acquiring unit that acquires viewer number information of predetermined content of a plurality of terminal devices;
a ranking information generating unit that values a terminal device having many viewers into a high ranking based on the viewer number information of the plurality of terminal devices acquired by the viewer number information acquiring unit, and generates ranking information of the plurality of terminal devices; and
a ranking information transmitting unit that transmits the ranking information generated by the ranking information generating unit to the terminal device.

18. The server device according to claim 17,
wherein the viewer number information acquiring unit receives the viewer number information of the predetermined content from the plurality of terminal devices, and acquires the viewer number information of the predetermined content of the plurality of terminal devices.

19. The server device according to claim 17, further comprising
a receiving unit that receives viewer-captured image data captured and obtained by a camera at a display period of time of the predetermined content from the plurality of terminal devices,
wherein the viewer number information acquiring unit processes the viewer-captured image data of the plurality of terminal devices received by the receiving unit, and acquires the viewer number information of the predetermined content of the plurality of terminal devices.

20. A ranking information transmission method of a server device, comprising the steps of:
acquiring viewer number information of predetermined content of a plurality of terminal devices;
valuing a terminal device having many viewers into a high ranking based on the viewer number information of the plurality of terminal devices acquired by the acquiring of the viewer number information, and generating ranking information of the plurality of terminal devices; and
transmitting the ranking information generated by the valuing of the terminal device to the terminal device.
